(19) United States
(12) Patent Application Publication
(10) Pub. No.: US 2024/0031844 A1
(43) Pub. Date: Jan. 25, 2024

(54) ENHANCED RADIO LINK FAILURE DETECTION IN NTN

(71) Applicant: Samsung Electronics Co., Ltd., Suwon-si (KR)

(72) Inventors: Kyeongin Jeong, Allen, TX (US); Shiyang Leng, Allen, TX (US)

(21) Appl. No.: 18/348,246

(22) Filed: Jul. 6, 2023

Related U.S. Application Data
(60) Provisional application No. 63/390,591, filed on Jul. 19, 2022.
(60) Provisional application No. 63/392,400, filed on Jul. 26, 2022.

(51) Int. Cl. H04W 24/08; H04W 64/00; H04B 7/185

(52) U.S. Cl. CPC H04W 24/08; H04W 64/00; H04B 7/18519

(57) ABSTRACT

Methods and apparatuses for an enhanced radio link failure (RLF) detection in a non-terrestrial network (NTN) are provided. A method of operating a user equipment (UE) includes identifying a value of a timer and a time value and determining that the timer has started upon detection of a radio link problem. The radio link problem is based on a first counter. The method further includes determining that a current time is passed the time value and detecting a radio link failure based on a determination that the timer has started and the current time is passed the time value.

### CROSS-REFERENCE TO RELATED APPLICATIONS AND CLAIM OF PRIORITY

The present application claims priority to U.S. Provisional Patent Application No. 63/390,591, filed on Jul. 19, 2022, and U.S. Provisional Patent Application No. 63/392,400, filed on Jul. 26, 2022. The content of the above-identified patent document is incorporated herein by reference.

### TECHNICAL FIELD

The present disclosure relates generally to wireless communication systems and, more specifically, the present disclosure relates to an enhanced radio link failure (RLF) detection in a non-terrestrial network (NTN).

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to an enhanced RLF detection in an NTN.

In one embodiment, a user equipment (UE) is provided. The UE comprises a transceiver and a processor operably coupled to the transceiver, the processor configured to: identify a value of a timer and a time value; determine that the timer has started upon detection of a radio link problem, wherein the radio link problem is based on a first counter; determine that a current time is passed the time value; and detect a radio link failure based on a determination that the timer has started and the current time is passed the time value.

In another embodiment, a method of a UE is provided. The UE comprises: identifying a value of a timer and a time value; determining that the timer has started upon detection of a radio link problem, wherein the radio link problem is based on a first counter; determining that a current time is passed the time value; and detecting a radio link failure based on a determination that the timer has started and the current time is passed the time value.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6 illustrates an example of NTN communication according to embodiments of the present disclosure;

FIG. 7 illustrates an example of NTN quasi-earth fixed cell according to embodiments of the present disclosure;

FIG. 8 illustrates signaling flows of an RRC re-establishment procedure according to embodiments of the present disclosure;

FIGS. 9A and 9B illustrate signaling flows of RRC re-establishment, fallback to RRC establishment, successful, according to embodiments of the present disclosure;

FIG. 10 illustrates signaling flows of an enhanced RLF detection according to embodiments of the present disclosure;

FIG. 11 illustrates a flowchart of UE operation for an enhanced RLF detection according to embodiments of the present disclosure;

FIG. 12 illustrates signaling flows of an enhanced RLF detection according to embodiments of the present disclosure;

FIG. 13 illustrates a flowchart of UE operation for an enhanced RLF detection according to embodiments of the present disclosure;

FIGS. 14A and 14B illustrate signaling flows of basic HO according to embodiments of the present disclosure;

FIGS. 15A and 15B illustrate signaling flows of basic CHO according to embodiments of the present disclosure;

FIG. 16 illustrates signaling flows of an enhanced HO according to embodiments of the present disclosure;

FIG. 17 illustrates flowchart of UE operation for an enhanced HO according to embodiments of the present disclosure; and

FIG. 18 illustrates a flowchart of UE method for an enhanced RLF detection in NTN according to embodiments of the present disclosure.

### DETAILED DESCRIPTION

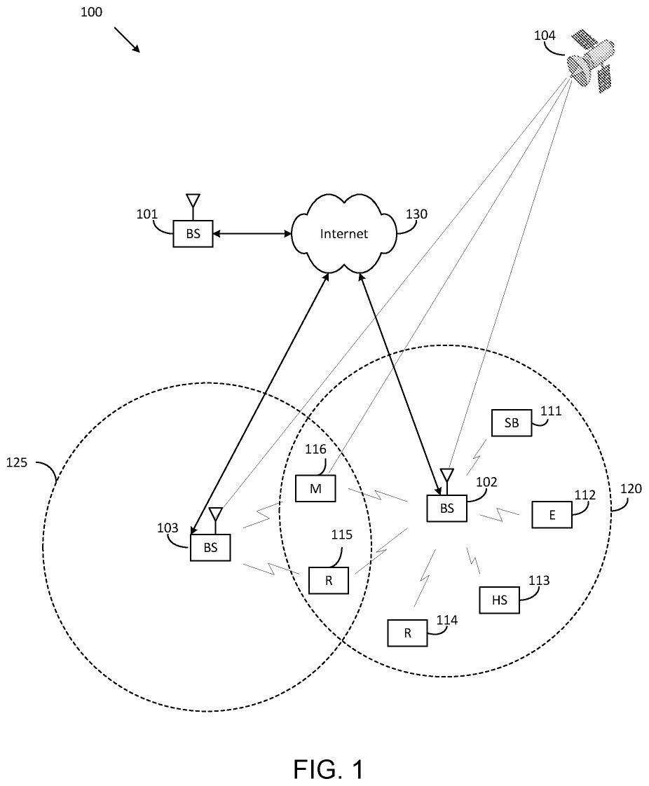

FIG. 1 through FIG. 18, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein:

3GPP TR 38.821 v16.1.0: “Solutions for NR to support non-terrestrial networks (NTN)”; 3GPP TS 38.321 v.17.1.0: “NR; Medium Access Control (MAC) protocol specification”; 3GPP TS 38.331 v17.1.0: “NR; Radio Resource Control (RRC) protocol specification”; 3GPP TS 38.304 v17.1.0: “NR; User Equipment (UE) procedures in Idle mode and RRC inactive state”; and 3GPP TS 37.355 v17.1.0: “LTE Positioning Protocol (LPP).”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably-arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of UEs within a coverage area 120 of the gNB 102. The first plurality of UEs includes a UE 111, which may be located in a small business; a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M), such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3GPP NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As discussed in greater detail below, the wireless network 100 may have communications facilitated via one or more communication satellite(s) 104 that may be in orbit over the earth. The communication satellite(s) 104 can communicate directly with the BSs 102 and 103 to provide network access, for example, in situations where the BSs 102 and 103 are remotely located or otherwise in need of facilitation for network access connections beyond or in addition to traditional fronthaul and/or backhaul connections. Various of the UEs (e.g., as depicted by UE 116) may be capable of at least some direct communication and/or localization with the communication satellite(s) 104, for example, to receive positional information or coordinates.

An NTN refers to a network, or segment of networks using RF resources on board a communication satellite (or unmanned aircraft system platform) (e.g., communication satellite(s) 104). Considering the capabilities of providing wide coverage and reliable service, an NTN is envisioned to ensure service availability and continuity ubiquitously. For instance, an NTN can support communication services in unserved areas that cannot be covered by conventional terrestrial networks, in underserved areas that are experiencing limited communication services, for devices and passengers on board moving platforms, and for future railway/maritime/aeronautical communications, etc.

As described in more detail below, one or more of the UEs 111-116 include circuitry, programing, or a combination thereof, to support an enhanced RLF detection in a NTN. In certain embodiments, and one or more of the gNBs 101-103 includes circuitry, programing, or a combination thereof, to support an enhanced RLF detection in a NTN.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

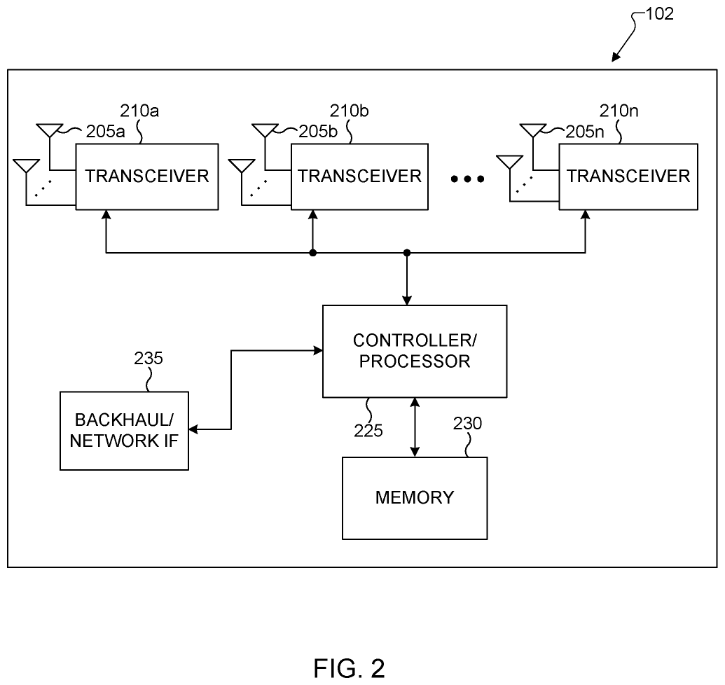

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process. The controller/processor 225 is also capable of executing programs and other processes resident in the memory 230, such as processes to support an enhanced RLF detection in an NTN in a wireless communication system.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

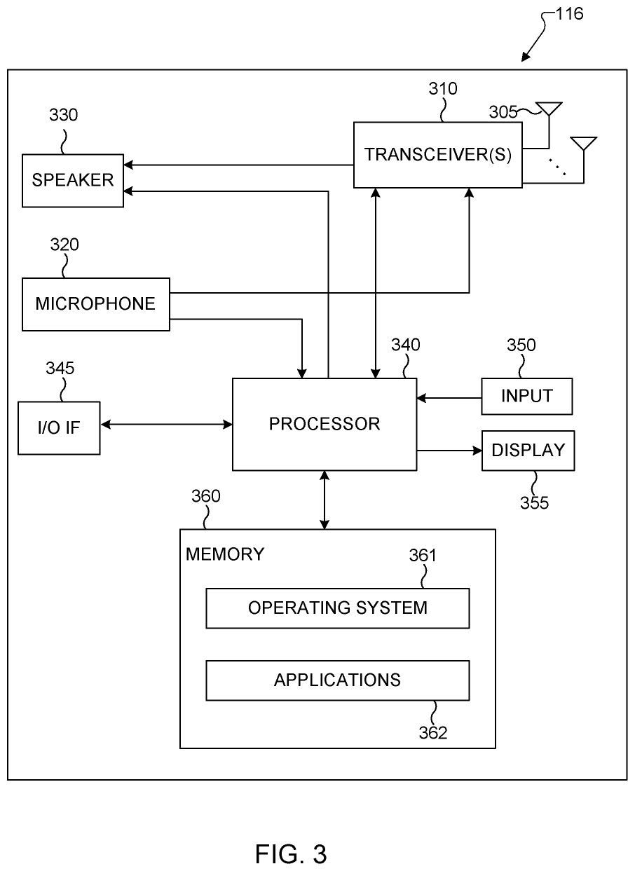

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as support for an enhanced RLF detection in a NTN in a wireless communication system. The processor 340 can move data into or out of the memory 360 as required by an executing process. In some embodiments, the processor 340 is configured to execute the applications 362 based on the OS 361 or in response to signals received from gNB s or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

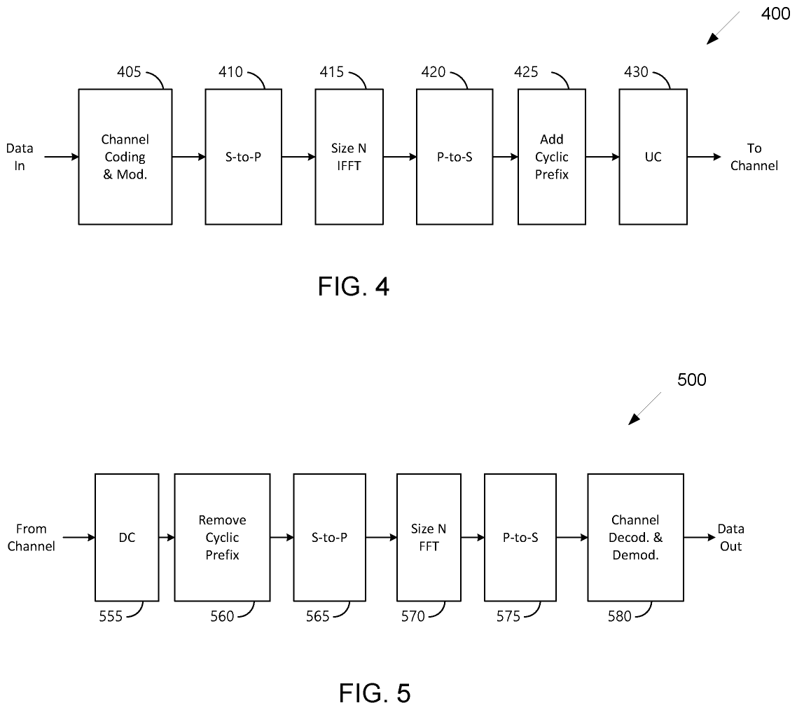

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support enhanced RLF detection in a NTN as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNB s 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNB s 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

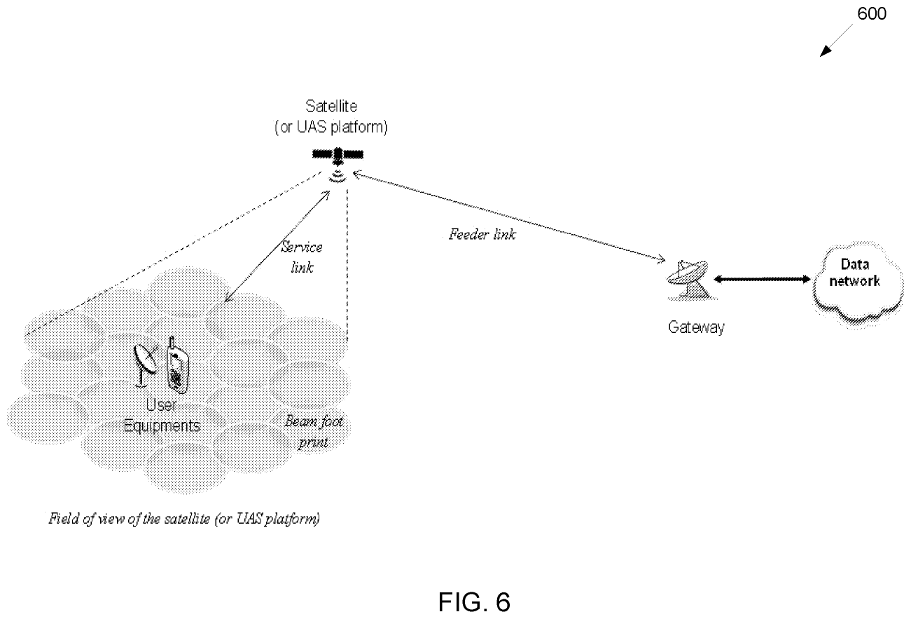

FIG. 6 illustrates an example of NTN communication 600 according to embodiments of the present disclosure. An embodiment of the NTN communication 600 shown in FIG. 6 is for illustration only.

In 3GPP wireless standards, new radio access technology (NR) is discussed as 5G wireless communication technology. One of NR feature under the discussion is an NTN. An NTN refers to a network, or segment of networks using RF resources on board a satellite (or unmanned aircraft system (UAS) platform) as shown FIG. 6. An NTN typically features the following example elements.

In one example, one or several sat-gateways may connect the NTN to a public data network.

In one example, a geostationary earth orbit (GEO), circular orbit at 35,786 km above the Earth's equator and following the direction of the Earth's rotation) satellite is fed by one or several sat-gateways which are deployed across the satellite targeted coverage (e.g., regional or even continental coverage). It may be assumed that UEs in a cell are served by only one sat-gateway.

In one example, a non-GEO satellite is served successively by one or several sat-gateways at a time. The system ensures service and feeder link continuity between the successive serving sat-gateways with sufficient time duration to proceed with mobility anchoring and handover. A LEO (Low Earth Orbit: orbit around the Earth with an altitude between 300 km, and 1500 km) satellite can be one example.

In one example, a feeder link or radio link between a sat-gateway and the satellite (or UAS platform) is provided.

In one example, a service link or radio link between the user equipment and the satellite (or UAS platform) is provided.

In one example, a satellite (or UAS platform) may implement either a transparent or a regenerative (with on board processing) payload. The satellite (or UAS platform) generates beams typically generate several beams over a given service area bounded by a field of view. The footprints of the beams are typically of elliptic shape. The field of view of a satellite (or UAS platform) depends on the on-board antenna diagram and min elevation angle.

In one example, a transparent payload is provided: radio frequency filtering, frequency conversion and amplification. Hence, the waveform signal repeated by the payload is un-changed.

In one example, a regenerative payload is provided: radio frequency filtering, frequency conversion and amplification as well as demodulation/decoding, switch and/or routing, coding/modulation. This is effectively equivalent to having all or part of base station functions (e.g., gNB) on board the satellite (or UAS platform).

In one example, inter-satellite links (ISL) is optionally provided in case of a constellation of satellites. This will require regenerative payloads on board the satellites. ISL may operate in RF frequency or optical bands.

In one example, a UE is served by the satellite (or UAS platform) within the targeted service area.

In 3GPP Release-17 (Rel-17), the basic features of NTN are introduced and further enhanced features are to be considered in Rel-18. One of the features is to support service continuity enhancements. A service may be interrupted if a radio link between the UE and satellite is failed/broken. This embodiment provides a fast RLF detection in NTN, so the UE can re-establish RRC connection more quickly upon radio link failure. With this embodiment, better service continuity can be achieved.

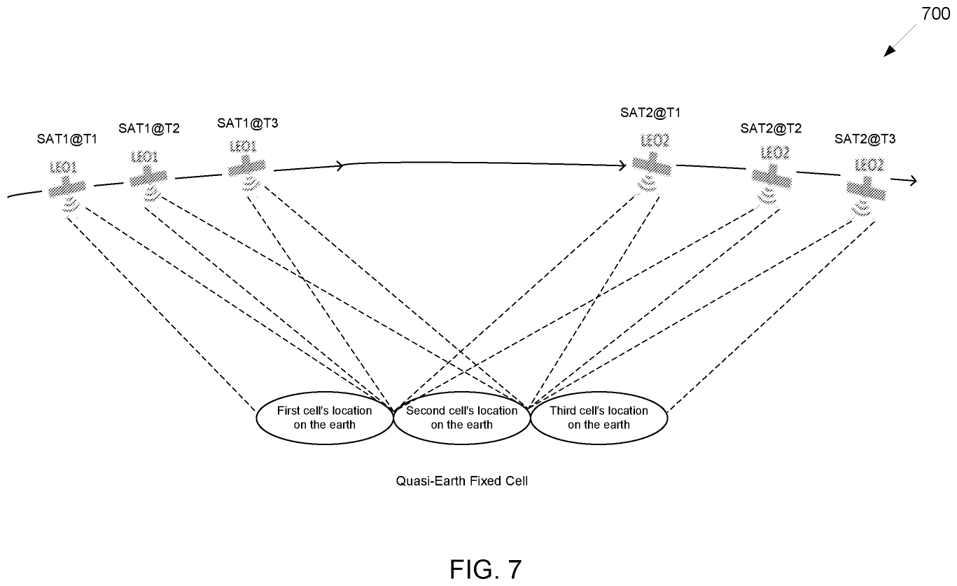

FIG. 7 illustrates an example of NTN quasi-earth fixed cell 700 according to embodiments of the present disclosure. An embodiment of the NTN quasi-earth fixed cell 700 1000 shown in FIG. 7 is for illustration only.

FIG. 7 describes one example of how NTN provides cells that are fixed with respect to a certain location on the earth during a certain time duration. This can be achieved with NTN platforms generating steerable beams which footprint is fixed on the ground. It may be assumed that satellite 1 (SAT 1) (here it is also called as low-Earth orbit 1 (LEO 1) and satellite 2 (SAT 2) (here it is also called as LEO 2) are moving from the west to east direction. T1, T2, and T3 indicates certain consecutive time duration (e.g., T1 is between absolute time t1 to t2, T2 is between absolute time t2 to t3, and T3 is between absolute time t3 to t4).

During T1 duration, SAT 1 provides NR service to the first cell's location on the earth and SAT 2 provides NR service to the second cell's location on the earth. During T2 duration, both SAT 1 and SAT 2 provides NR service to the second cell's location on the earth. It is noted that a physical cell identifier (PCI) of the second cell's location on the earth by SAT 1 and SAT 2 can be different, which means the second cell's location on the earth is covered by two PCIs. In the case, each PCI and the associated NR service are provided by each satellite (e.g., SAT 1 and SAT 2).

It is also noted that the frequency location of the synchronization signal block (SSB) that includes cell's PCI information can be different between two cells in order to avoid strong interference in the case two cells are entirely overlapped. For instance, during T2 duration the second cell's location on the earth is served by PCI #N carried by SSB located in the carrier #1 by SAT 1 while the second cell's location is served by PCI #M carried by SSB located in the carrier #2 by SAT2. However, the PCI #M by SAT 2 may be disappeared later since SAT 2 may serve the third cell's location on the earth during the following T3 duration. This type of NTN cell (or service link) is called as quasi-earth fixed cell.

It is noted that following three types of NTN cell (or service link) can be supported: (1) Earth-fixed: provisioned by beam(s) continuously covering the same geographical areas all the time (e.g., the case of GSO satellites); (2) quasi-Earth-fixed: provisioned by beam(s) covering one geographic area for a limited period and a different geographic area during another period (e.g., the case of NGSO satellites generating steerable beams); and (3) Earth-moving: provisioned by beam(s) whose coverage area slides over the Earth surface (e.g., the case of NGSO satellites generating fixed or non-steerable beams).

With NGSO satellites, the gNB can provide either quasi-Earth-fixed cell coverage or Earth-moving cell coverage, while gNB operating with GSO satellite can provide Earth fixed cell coverage.

In NR, in order the UE to determine whether the radio link between the UE and the gNB (or the satellite) is broken or not, a radio link failure detection mechanism is specified. In an RRC_CONNECTED state, the UE performs radio link monitoring (RLM) in the active bandwidth part (BWP) based on reference signals (SSB: SS/PBCH block or CSI-RS: channel status information—reference signal) and signal quality thresholds configured by the network. SSB-based RLM is based on the SSB associated to the initial DL BWP and can only be configured for the initial DL BWP and for DL BWPs containing the SSB associated to the initial DL BWP. For other DL BWPs, RLM can only be performed based on CSI-RS.

In case of dual active protocol stack (DAPS) handover, the UE continues the detection of radio link failure at the source cell until the successful completion of the random access procedure to the target cell. The UE behavior in the point of how to detect physical layer problem, recovery of physical layer problem and radio link failure is specified in 3GPP standard specification as shown TABLES below.

TABLE 1
Detection of physical layer problems in RRC_CONNECTED

| | |
|---|---|
| 5.3.10.1 | Detection of physical layer problems in RRC_CONNECTED |

The UE may:

| | |
|---|---|
| 1> | if any DAPS bearer is configured, upon receiving N310 consecutive “out-of- |

sync” indications for the source SpCell from lower layers and T304 is running:

| | |
|---|---|
| | 2> start timer T310 for the source SpCell. |
| 1> | upon receiving N310 consecutive “out-of-sync” indications for the SpCell from |

lower layers while neither T300, T301, T304, T311, T316, nor T319 are running:

2> start timer T310 for the corresponding SpCell.

TABLE 2
Recovery of physical layer problems

| | |
|---|---|
| 5.3.10.2 | Recovery of physical layer problems |

Upon receiving N311 consecutive “in-sync” indications for the SpCell from lower layers while
T310 is running, the UE may:

| | |
|---|---|
| 1> | stop timer T310 for the corresponding SpCell. |
| 1> | stop timer T312 for the corresponding SpCell, if running. |
| NOTE 1: | In this case, the UE maintains the RRC connection without explicit signalling, |

i.e., the UE maintains the entire radio resource configuration.

| | |
|---|---|
| NOTE 2: | Periods in time where neither “in-sync” nor “out-of-sync” is reported by L1 do |

not affect the evaluation of the number of consecutive “in-sync” or “out-of-sync” indications.

TABLE 3
Detection of radio link failure

| | |
|---|---|
| 5.3.10.3 | Detection of radio link failure |

The UE may:

| 1> | if any DAPS bearer is configured and T304 is running: | |
|---|---|---|
| | 2> | upon T310 expiry in source SpCell; or |
| | 2> | upon random access problem indication from source MCG MAC; or |
| | 2> | upon indication from source MCG RLC that the maximum number of |

retransmissions has been reached; or

| | |
|---|---|
| 2> | upon consistent uplink LBT failure indication from source MCG MAC: |

| | |
|---|---|
| 3> | consider radio link failure to be detected for the source MCG i.e., |

source RLF;

| | |
|---|---|
| 3> | suspend the transmission and reception of all DRBs and multicast |

MRBs in the source MCG;

| | |
|---|---|
| 3> | reset MAC for the source MCG; |
| 3> | release the source connection. |

| 1> | else: | |
|---|---|---|
| | 2> | during a DAPS handover: the following only applies for the target PCell; |
| | 2> | upon T310 expiry in PCell; or |
| | 2> | upon T312 expiry in PCell; or |
| | 2> | upon random access problem indication from MCG MAC while neither |

T300, T301, T304, T311 nor T319 are running; or

| | |
|---|---|
| 2> | upon indication from MCG RLC that the maximum number of |

retransmissions has been reached; or

| | |
|---|---|
| 2> | if connected as an IAB-node, upon BH RLF indication received on BAP |

entity from the MCG; or

| | |
|---|---|
| 2> | upon consistent uplink LBT failure indication from MCG MAC while |

T304 is not running:

| | |
|---|---|
| 3> | if the indication is from MCG RLC and CA duplication is |

configured and activated for MCG, and for the corresponding logical channel
allowedServingCells only includes SCell(s):

| | |
|---|---|
| 4> | initiate the failure information procedure as specified in |

5.7.5 to report RLC failure.

| | |
|---|---|
| 3> | else: |

| | |
|---|---|
| 4> | consider radio link failure to be detected for the MCG, i.e., |

MCG RLF;

| | |
|---|---|
| 4> | discard any segments of segmented RRC messages stored |

according to 5.7.6.3;

| | |
|---|---|
| NOTE: | Void. |

| | |
|---|---|
| 4> | if AS security has not been activated: |

| | |
|---|---|
| 5> | perform the actions upon going to RRC_IDLE as |

specified in 5.3.11, with release cause “other”;-

| | |
|---|---|
| 4> | else if AS security has been activated but SRB2 and at |

least one DRB or multicast MRB or, for IAB, SRB2, have not been setup:

| | | |
|---|---|---|
| | 5> | store the radio link failure information in the |
| VarRLF-Report as described in clause 5.3.10.5; | | |
| | 5> | perform the actions upon going to RRC_IDLE as |

specified in 5.3.11, with release cause “RRC connection failure”;

| | |
|---|---|
| 4> | else: |

| | |
|---|---|
| 5> | store the radio link failure information in the |

VarRLF-Report as described in clause 5.3.10.5;

| | |
|---|---|
| 5> | if T316 is configured; and |
| 5> | if SCG transmission is not suspended; and |
| 5> | if the SCG is not deactivated; and |
| 5> | if neither PSCell change nor PSCell addition is |

ongoing (i.e., timer T304 for the NR PSCell is not running in case of NR-DC or timer T307 of
the E-UTRA PSCell is not running as specified in TS 36.331, clause 5.3.10.10, in NE-DC):

6> initiate the MCG failure information

procedure as specified in 5.7.3b to report MCG radio link failure.

| | |
|---|---|
| 5> | else: |
| | 6> initiate the connection re-establishment |

procedure as specified in 5.3.7.

Once the UE detects a radio link failure, the UE performs as follow: (1) stays in RRC_CONNECTED; (2) in case of DAPS handover, for RLF in the source cell: (a) stops any data transmission or reception via the source link and releases the source link, but maintains the source RRC configuration; (3) if handover failure is then declared at the target cell, the UE: (a) selects a suitable cell and then initiates RRC re-establishment; and (b) enters RRC_IDLE if a suitable cell was not found within a certain time after handover failure was declared; (4) in case of CHO, for RLF in the source cell: (a) selects a suitable cell and if the selected cell is a CHO candidate and if network configured the UE to try CHO after RLF then the UE attempts CHO execution once, otherwise re-establishment is performed; and (b) enters RRC_IDLE if a suitable cell was not found within a certain time after RLF was declared; (5) otherwise, for RLF in the serving cell or in case of DAPS handover, for RLF in the target cell before releasing the source cell: (a) selects a suitable cell and then initiates RRC re-establishment; and (b) enters RRC_IDLE if a suitable cell was not found within a certain time after RLF was declared.

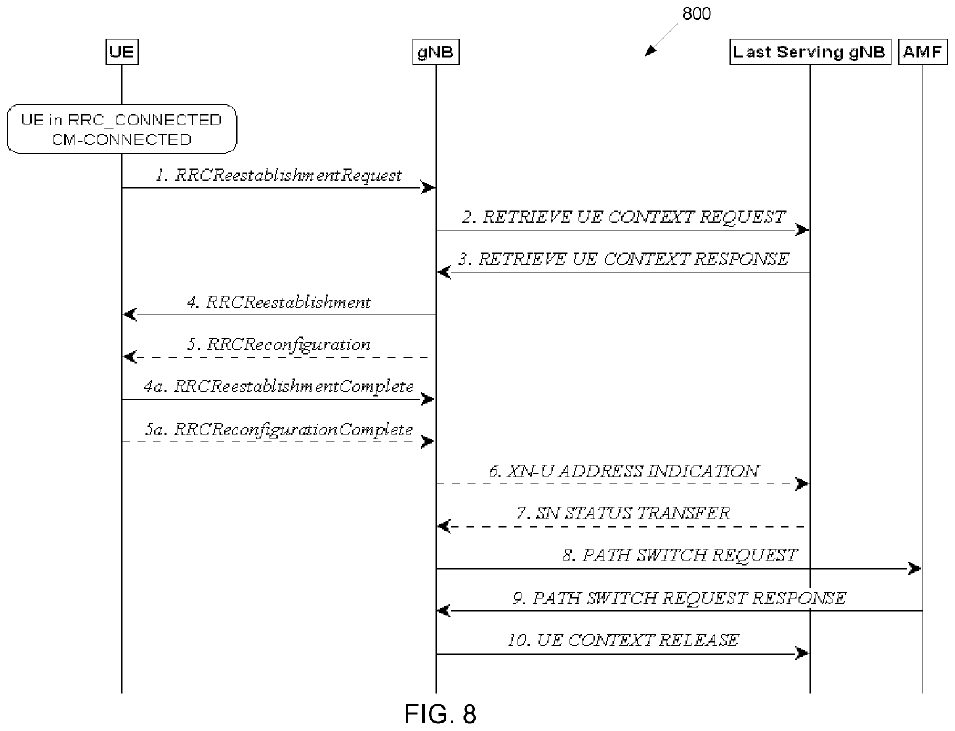

FIG. 8 illustrates signaling flows of an RRC re-establishment procedure 800 according to embodiments of the present disclosure. The RRC re-establishment procedure 800 as may be performed by a UE (e.g., 111-116 as illustrated in FIG. 1) and a base station (e.g., 101-103 as illustrated in FIG. 1). An embodiment of the RRC re-establishment procedure 800 shown in FIG. 8 is for illustration only. One or more of the components illustrated in FIG. 8 can be implemented in specialized circuitry configured to perform the noted functions or one or more of the components can be implemented by one or more processors executing instructions to perform the noted functions.

FIG. 8 describes an example of RRC re-establishment procedure. A UE in RRC_CONNECTED may initiate the re-establishment procedure to continue the RRC connection when a failure condition occurs (e.g., radio link failure, reconfiguration failure, integrity check failure . . . ).

The following figure describes the re-establishment procedure started by the UE. As illustrated in FIG. 8, in step 1, the UE re-establishes the connection, providing the UE Identity (PCI+C-RNTI) to the gNB where the trigger for the re-establishment occurred. In step 2, if the UE context is not locally available, the gNB, requests the last serving gNB to provide UE context data. In step 3, the last serving gNB provides UE context data. In step 4/4a, the gNB continues the re-establishment of the RRC connection. The message is sent on SRB1. In step 5/5a, the gNB may perform the reconfiguration to re-establish SRB2 and DRBs when the re-establishment procedure is ongoing. In step 6/7, if loss of user data buffered in the last serving gNB may be prevented, the gNB provides forwarding addresses, and the last serving gNB provides the SN status to the gNB. In step 8/9, the gNB performs path switch. In step 10, the gNB triggers the release of the UE resources at the last serving gNB.

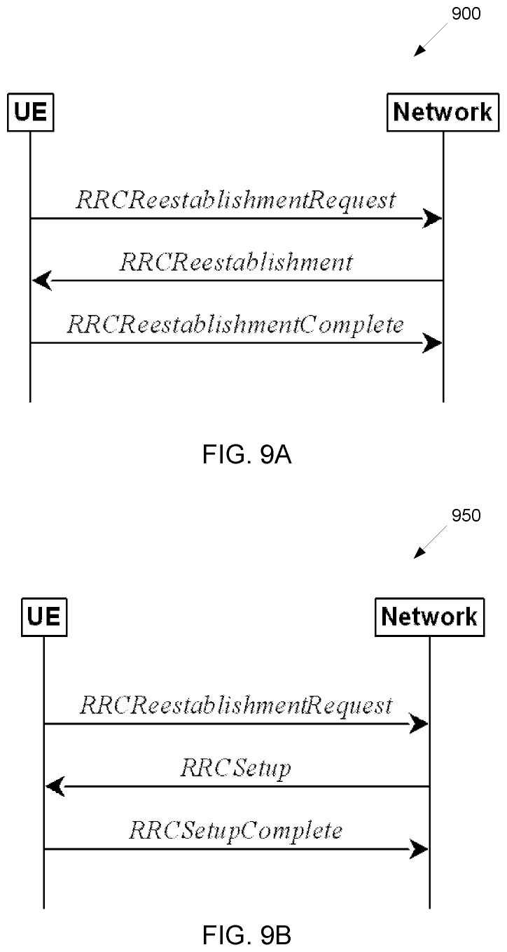

FIG. 9A illustrates signaling flows 900 of RRC re-establishment, fallback to RRC establishment, successful, according to embodiments of the present disclosure. The signaling flows 900 as may be performed by a UE (e.g., 111-116 as illustrated in FIG. 1) and a base station (e.g., 101-103 as illustrated in FIG. 1). An embodiment of the signaling flows 900 shown in FIG. 9A is for illustration only. One or more of the components illustrated in FIG. 9A can be implemented in specialized circuitry configured to perform the noted functions or one or more of the components can be implemented by one or more processors executing instructions to perform the noted functions.

FIG. 9B illustrates signaling flows 950 of RRC re-establishment, fallback to RRC establishment, successful, according to embodiments of the present disclosure. The signaling flows 900 as may be performed by a UE (e.g., 111-116 as illustrated in FIG. 1) and a base station (e.g., 101-103 as illustrated in FIG. 1). An embodiment of the signaling flows 950 shown in FIG. 9B is for illustration only. One or more of the components illustrated in FIG. 9B can be implemented in specialized circuitry configured to perform the noted functions or one or more of the components can be implemented by one or more processors executing instructions to perform the noted functions.

FIGS. 9A and 9B describe only for an RRC procedure of RRC re-establishment between the UE and the gNB. The corresponding UE behaviour is specified as follow. The purpose of this procedure is to a re-establish the RRC connection. A UE in an RRC_CONNECTED state, for which AS security has been activated with SRB2 and at least one DRB/multicast MRB setup or, for IAB, SRB2, may initiate the procedure in order to continue the RRC connection. The connection re-establishment succeeds if the network is able to find and verify a valid UE context or, if the UE context cannot be retrieved, and the network responds with an RRCSetup according to clause 3GPP standard specification.

The network applies the procedure as follows. When AS security has been activated and the network retrieves or verifies the UE context: (1) to re-activate AS security without changing algorithms; and (2) to re-establish and resume the SRB1. When a UE is re-establishing an RRC connection, and the network is not able to retrieve or verify the UE context: (1) to discard the stored AS Context and release all RBs and BH RLC channels and Uu relay RLC channels; and (2) to fallback to establish a new RRC connection.

If AS security has not been activated, the UE may not initiate the procedure but instead moves to RRC_IDLE directly, with release cause “other.” If AS security has been activated, but SRB2 and at least one DRB or multicast MRB or, for IAB, SRB2, are not setup, the UE does not initiate the procedure but instead moves to RRC_IDLE directly, with release cause “RRC connection failure.”

TABLE 4
Initiation

| | |
|---|---|
| 5.3.7.2 | Initiation |

The UE initiates the procedure when one of the following conditions is met:

| | |
|---|---|
| 1> | upon detecting radio link failure of the MCG and t316 is not configured, in |

accordance with 5.3.10; or

| | |
|---|---|
| 1> | upon detecting radio link failure of the MCG while SCG transmission is |

suspended, in accordance with 5.3.10; or

| | |
|---|---|
| 1> | upon detecting radio link failure of the MCG while PSCell change or PSCell |

addition is ongoing, in accordance with 5.3.10; or

| | |
|---|---|
| 1> | upon re-configuration with sync failure of the MCG, in accordance with clause |

5.3.5.8.3; or

| | |
|---|---|
| 1> | upon mobility from NR failure, in accordance with clause 5.4.3.5; or |
| 1> | upon integrity check failure indication from lower layers concerning SRB1 or |

SRB2, except if the integrity check failure is detected on the RRCReestablishment message; or

| | |
|---|---|
| 1> | upon an RRC connection reconfiguration failure, in accordance with clause |

5.3.5.8.2; or

| | |
|---|---|
| 1> | upon detecting radio link failure for the SCG while MCG transmission is |

suspended, in accordance with clause 5.3.10.3 in NR-DC or in accordance with TS 36.331 clause
5.3.11.3 in NE-DC; or

| | |
|---|---|
| 1> | upon reconfiguration with sync failure of the SCG while MCG transmission is |

suspended in accordance with clause 5.3.5.8.3; or

| | |
|---|---|
| 1> | upon SCG change failure while MCG transmission is suspended in accordance |

with TS 36.331 clause 5.3.5.7a; or

| | |
|---|---|
| 1> | upon SCG configuration failure while MCG transmission is suspended in |

accordance with clause 5.3.5.8.2 in NR-DC or in accordance with TS 36.331 [10] clause 5.3.5.5
in NE-DC; or

| | |
|---|---|
| 1> | upon integrity check failure indication from SCG lower layers concerning SRB3 |

while MCG is suspended; or

| | |
|---|---|
| 1> | upon T316 expiry, in accordance with clause 5.7.3b.5; or |
| 1> | upon detecting sidelink radio link failure by L2 U2N Remote UE in |

RRC_CONNECTED, in accordance with clause 5.8.9.3; or

| | |
|---|---|
| 1> | upon reception of NotificationMessageSidelink including indicationType by L2 |

U2N Remote UE in RRC_CONNECTED, in accordance with clause 5.8.9.10.
Upon initiation of the procedure, the UE may:

| 1> | stop timer T310, if running; | |
|---|---|---|
| 1> | stop timer T312, if running; | |
| 1> | stop timer T304, if running; | |
| 1> | start timer T311; | |
| 1> | stop timer T316, if running; | |
| 1> | if UE is not configured with conditionalReconfiguration: | |
| | 2> | reset MAC; |
| | 2> | release spCellConfig, if configured; |
| | 2> | suspend all RBs, and BH RLC channels for IAB-MT, and Uu Relay RLC |

channels for L2 U2N Relay UE, except SRB0;

| | |
|---|---|
| 2> | release the MCG SCell(s), if configured; |
| 2> | if MR-DC is configured: |
| | 3> perform MR-DC release, as specified in clause 5.3.5.10; |
| 2> | release delayBudgetReportingConfig, if configured and stop timer T342, |

if running;

| | |
|---|---|
| 2> | release overheatingAssistanceConfig, if configured and stop timer T345, |

if running;

| | |
|---|---|
| 2> | release idc-AssistanceConfig, if configured; |
| 2> | release btNameList, if configured; |
| 2> | release wlanNameList, if configured; |
| 2> | release sensorNameList, if configured; |
| 2> | release drx-PreferenceConfig for the MCG, if configured and stop timer |

T346a associated with the MCG, if running;

| | |
|---|---|
| 2> | release maxBW-PreferenceConfig for the MCG, if configured and stop |

timer T346b associated with the MCG, if running;

| | |
|---|---|
| 2> | release maxCC-PreferenceConfig for the MCG, if configured and stop |

timer T346c associated with the MCG, if running;

| | |
|---|---|
| 2> | release maxMIMO-LayerPreferenceConfig for the MCG, if configured |

and stop timer T346d associated with the MCG, if running;

| | |
|---|---|
| 2> | release minSchedulingOffsetPreferenceConfig for the MCG, if |

configured stop timer T346e associated with the MCG, if running;

| | |
|---|---|
| 2> | release rlm-RelaxationReportingConfig for the MCG, if configured and |

stop timer T346j associated with the MCG, if running;

| | |
|---|---|
| 2> | release bfd-RelaxationReportingConfig for the MCG, if configured and |

stop timer T346k associated with the MCG, if running;

| | |
|---|---|
| 2> | release releasePreferenceConfig, if configured stop timer T346f, if |

running;

| | |
|---|---|
| 2> | release onDemandSIB-Request if configured, and stop timer T350, if |

running;

| | |
|---|---|
| 2> | release referenceTimePreferenceReporting, if configured; |
| 2> | release sl-AssistanceConfigNR, if configured; |
| 2> | release obtainCommonLocation, if configured; |
| 2> | release musim-GapAssistanceConfig, if configured and stop timer T346h, |

if running;

| | |
|---|---|
| 2> | release musim-LeaveAssistanceConfig, if configured; |
| 2> | release scg-DeactivationPreferenceConfig, if configured, and stop timer |

T346i, if running;

| 1> | release successHO-Config, if configured; | |
|---|---|---|
| 1> | if any DAPS bearer is configured: | |
| | 2> | reset the source MAC and release the source MAC configuration; |
| | 2> | for each DAPS bearer: |
| | | 3> release the RLC entity or entities as specified in TS 38.322, clause |

5.1.3, and the associated logical channel for the source SpCell;

3> reconfigure the PDCP entity to release DAPS as specified in TS

38.323;

| | |
|---|---|
| 2> | for each SRB: |
| | 3> release the PDCP entity for the source SpCell; |
| | 3> release the RLC entity as specified in TS 38.322, clause 5.1.3, and |

the associated logical channel for the source SpCell;

| | |
|---|---|
| 2> | release the physical channel configuration for the source SpCell; |
| 2> | discard the keys used in the source |
| | SpCell (the K_{gNB} key, the K_{RRCenc} key, |

the K_{RRCint} key, the K_{UPint} key and the K_{UPenc} key), if any;

| | |
|---|---|
| 1> | release sl-L2RelayUEConfig, if configured; |
| 1> | release sl-L2RemoteUEConfig, if configured; |
| 1> | release the SRAP entity, if configured; |
| 1> | if the UE is connected with a L2 U2N Relay UE via PC5-RRC connection (i.e., |

the UE is a L2 U2N Remote UE):

| | | |
|---|---|---|
| | 2> | if the PC5-RRC connection with the U2N Relay UE is determined to be |
| released: | | |
| | | 3> perform the PC5-RRC connection release as specified in 5.8.9.5; |
| | | 3> perform either cell selection in accordance with the cell selection |

process as specified in TS 38.304, or relay selection as specified in clause 5.8.15.3, or both;

| | |
|---|---|
| 2> | else maintain the PC5 RRC connection and stop T311 if running; |

| | |
|---|---|
| NOTE 1: | It is up to Remote UE implementation whether to release or keep the current |

unicast PC5 link.
1> else:

| | |
|---|---|
| 2> | perform cell selection in accordance with the cell selection process as |

specified in TS 38.304 [20].

| | |
|---|---|
| NOTE 2: | For L2 U2N Remote UE, if both a suitable cell and a suitable relay are available, |

the UE can select either one based on its implementation.

TABLE 5
Actions following cell selection while T311 is running

| | |
|---|---|
| 5.3.7.3 | Actions following cell selection while T311 is running |

Upon selecting a suitable NR cell, the UE may:

| | |
|---|---|
| 1> | ensure having valid and up to date essential system information as specified in |

clause 5.2.2.2;

| 1> | stop timer T311; | |
|---|---|---|
| 1> | if T390 is running: | |
| | 2> | stop timer T390 for all access categories; |
| | 2> | perform the actions as specified in 5.3.14.4; |

| | |
|---|---|
| 1> | if the cell selection is triggered by detecting radio link failure of the MCG or re- |

configuration with sync failure of the MCG or mobility from NR failure, and

| | |
|---|---|
| 1> | if attemptCondReconfig is configured; and |
| 1> | if the selected cell is one of the candidate cells for which the |

reconfigurationWithSync is included in the masterCellGroup in VarConditionalReconfig:

| | |
|---|---|
| 2> | set the choCellId in the VarRLF-Report to the global cell identity and |

tracking area code, if available, otherwise to the physical cell identity and carrier frequency of
the selected cell;

| | |
|---|---|
| 2> | apply the stored condRRCReconfig associated to the selected cell and |

perform actions as specified in 5.3.5.3;

| | |
|---|---|
| NOTE 1: | It is left to network implementation to how to avoid keystream reuse in case of |

CHO based recovery after a failed handover without key change.

| 1> | else: | |
|---|---|---|
| | 2> | if UE is configured with conditionalReconfiguration: |

| | |
|---|---|
| 3> | reset MAC; |
| 3> | release spCellConfig, if configured; |
| 3> | release the MCG SCell(s), if configured; |
| 3> | release delayBudgetReportingConfig, if configured and stop timer |

T342, if running;

| | |
|---|---|
| 3> | release overheatingAssistanceConfig , if configured and stop |

timer T345, if running;

| | |
|---|---|
| 3> | if MR-DC is configured: |
| | 4> perform MR-DC release, as specified in clause 5.3.5.10; |
| 3> | release idc-AssistanceConfig, if configured; |
| 3> | release btNameList, if configured; |
| 3> | release wlanNameList, if configured; |
| 3> | release sensorNameList, if configured; |
| 3> | release drx-PreferenceConfig for the MCG, if configured and stop |

timer T346a associated with the MCG, if running;

| | |
|---|---|
| 3> | release maxBW-PreferenceConfig for the MCG, if configured and |

stop timer T346b associated with the MCG, if running;

| | |
|---|---|
| 3> | release maxCC-PreferenceConfig for the MCG, if configured and |

stop timer T346c associated with the MCG, if running;

| | |
|---|---|
| 3> | release maxMIMO-LayerPreferenceConfig for the MCG, if |

configured and stop timer T346d associated with the MCG, if running;

| | |
|---|---|
| 3> | release minSchedulingOffsetPreferenceConfig for the MCG, if |

configured and stop timer T346e associated with the MCG, if running;

| | |
|---|---|
| 3> | release rlm-RelaxationReportingConfig for the MCG, if |

configured and stop timer T346j associated with the MCG, if running;

| | |
|---|---|
| 3> | release bfd-RelaxationReportingConfig for the MCG, if |

configured and stop timer T346k associated with the MCG, if running;

| | |
|---|---|
| 3> | release releasePreferenceConfig, if configured and stop timer |

T346f, if running;

| | |
|---|---|
| 3> | release onDemandSIB-Request if configured, and stop timer |

T350, if running;

| | |
|---|---|
| 3> | release referenceTimePreferenceReporting, if configured; |
| 3> | release sl-AssistanceConfigNR, if configured; |
| 3> | release obtainCommonLocation, if configured; |
| 3> | release scg-DeactivationPreferenceConfig, if configured, and |

stop timer T346i, if running;

| | |
|---|---|
| 3> | suspend all RBs, except SRB0; |

| | |
|---|---|
| 2> | remove all the entries within VarConditionalReconfig, if any; |
| 2> | for each measId, if the associated reportConfig has a reportType set to |

condTriggerConfig:

| | |
|---|---|
| 3> | for the associated reportConfigId: |
| | 4> remove the entry with the matching reportConfigId from |

the reportConfigList within the VarMeasConfig;

| | |
|---|---|
| 3> | if the associated measObjectId is only associated to a |

reportConfig with reportType set to condTriggerConfig:

4> remove the entry with the matching measObjectId from

the measObjectList within the VarMeasConfig;

| | |
|---|---|
| 3> | remove the entry with the matching measId from the measIdList |

within the VarMeasConfig;

| | |
|---|---|
| 2> | start timer T301; |
| 2> | apply the default L1 parameter values as specified in corresponding |

physical layer specifications except for the parameters for which values are provided in SIB1;

| | |
|---|---|
| 2> | apply the default MAC Cell Group configuration as specified in 9.2.2; |
| 2> | apply the CCCH configuration as specified in 9.1.1.2; |
| 2> | apply the timeAlignmentTimerCommon included in SIB1; |
| 2> | initiate transmission of the RRCReestablishmentRequest message in |

accordance with 5.3.7.4;

| | |
|---|---|
| NOTE 2: | This procedure applies also if the UE returns to the source PCell. |

Upon selecting an inter-RAT cell, the UE may:

| | |
|---|---|
| 1> | perform the actions upon going to RRC_IDLE as specified in 5.3.11, with release |

cause “RRC connection failure.”

TABLE 6
Actions related to transmission of RRCReestablishmentRequest message

| | |
|---|---|
| 5.3.7.4 | Actions related to transmission of RRCReestablishmentRequest message |

The UE may set the contents of RRCReestablishmentRequest message as follows:

| | |
|---|---|
| 1> | if the procedure was initiated due to radio link failure as specified in 5.3.10.3 or |

reconfiguration with sync failure as specified in 5.3.5.8.3:

| | |
|---|---|
| 2> | set the reestablishmentCellId in the VarRLF-Report to the global cell |

identity of the selected cell;

| 1> | set the ue-Identity as follows: | |
|---|---|---|
| | 2> | set the c-RNTI to the C-RNTI used in the source PCell (reconfiguration |

with sync or mobility from NR failure) or used in the PCell in which the trigger for the re-
establishment occurred (other cases);

| | |
|---|---|
| 2> | set the physCellId to the physical cell identity of the source PCell |

(reconfiguration with sync or mobility from NR failure) or of the PCell in which the trigger for
the re-establishment occurred (other cases);

| | |
|---|---|
| 2> | set the shortMAC-I to the 16 least significant bits of the MAC-I |

calculated:

3> over the ASN.1 encoded as per clause 8 (i.e., a multiple of 8 bits)

VarShortMAC-Input;

3> with the K_{RRCint} key and integrity protection algorithm that was

used in the source PCell (reconfiguration with sync or mobility from NR failure) or of the PCell
in which the trigger for the re-establishment occurred (other cases); and

3> with all input bits for COUNT, BEARER and DIRECTION set to

binary ones;

| 1> | set the reestablishmentCause as follows: | |
|---|---|---|
| | 2> | if the re-establishment procedure was initiated due to reconfiguration |

failure as specified in 5.3.5.8.2:

| | |
|---|---|
| | 3> set the reestablishmentCause to the value reconfigurationFailure; |
| 2> | else if the re-establishment procedure was initiated due to reconfiguration |

with sync failure as specified in 5.3.5.8.3 (intra-NR handover failure) or 5.4.3.5 (inter-RAT
mobility from NR failure):

| | |
|---|---|
| | 3> set the reestablishmentCause to the value handoverFailure; |
| 2> | else: |
| | 3> set the reestablishmentCause to the value otherFailure; |

| | |
|---|---|
| 1> | re-establish PDCP for SRB1; |
| 1> | if the UE is connected with a L2 U2N Relay UE via PC5-RRC connection (i.e., |

the UE is a L2 U2N Remote UE):

| | |
|---|---|
| 2> | apply the default configuration of SL-RLC1 as defined in 9.2.4 for SRB1; |
| 2> | apply the default configuration of PDCP defined in 9.2.1 for SRB1; |

1> else:

| | |
|---|---|
| 2> | re-establish RLC for SRB1; |
| 2> | apply the default configuration defined in 9.2.1 for SRB1; |

| | |
|---|---|
| 1> | configure lower layers to suspend integrity protection and ciphering for SRB1; |
| NOTE: | Ciphering is not applied for the subsequent RRCReestablishment message used |

to resume the connection. An integrity check is performed by lower layers, but merely upon
request from RRC.

| | |
|---|---|
| 1> | resume SRB1; |
| 1> | submit the RRCReestablishmentRequest message to lower layers for |

transmission.

TABLE 7
Reception of the RRCReestablishment by the UE

| | |
|---|---|
| 5.3.7.5 | Reception of the RRCReestablishment by the UE |

The UE may:

| | |
|---|---|
| 1> | stop timer T301; |
| 1> | if the RRCReestablishment message includes the sl-L2RemoteUEConfig (i.e., the |

UE is a L2 U2N Remote UE):

| | |
|---|---|
| 2> | perform the L2 U2N Remote UE configuration procedure as specified in |

5.3.5.16;

| 1> | else: | |
|---|---|---|
| | 2> | consider the current cell to be the PCell; |

| | |
|---|---|
| 1> | update the K_{gNB} key based on the current K_{gNB} key or the NH, using the received |

nextHopChainingCount value, as specified in TS 33.501;

| | |
|---|---|
| 1> | store the nextHopChainingCount value indicated in the RRCReestablishment |

message;

| | |
|---|---|
| 1> | derive the K_{RRCenc} and K_{UPenc} keys associated with the previously configured |

cipheringAlgorithm, as specified in TS 33.501;

| | |
|---|---|
| 1> | derive the K_{RRCint} and K_{UPint} keys associated with the previously configured |

integrityProtAlgorithm, as specified in TS 33.501.

| | |
|---|---|
| 1> | request lower layers to verify the integrity protection of the RRCReestablishment |

message, using the previously configured algorithm and the K_{RRCint} key;

| 1> | if the integrity protection check of the RRCReestablishment message fails: | |
|---|---|---|
| | 2> | perform the actions upon going to RRC_IDLE as specified in 5.3.11, with |

release cause “RRC connection failure,” upon which the procedure ends;

| | |
|---|---|
| 1> | configure lower layers to resume integrity protection for SRB1 using the |

previously configured algorithm and the K_{RRCint} key immediately, i.e., integrity protection may
be applied to all subsequent messages received and sent by the UE, including the message used
to indicate the successful completion of the procedure;

| | |
|---|---|
| 1> | configure lower layers to resume ciphering for SRB1 using the previously |

configured algorithm and, the K_{RRCenc} key immediately, i.e., ciphering may be applied to all
subsequent messages received and sent by the UE, including the message used to indicate the
successful completion of the procedure;

| | |
|---|---|
| 1> | release the measurement gap configuration indicated by the measGapConfig, if |

configured;

| | |
|---|---|
| 1> | release the measurement gap configuration indicated by the musim-GapConfig, |

if configured;

| 1> | set the content of RRCReestablishmentComplete message as follows: | |
|---|---|---|
| | 2> | if the UE has logged measurements available for NR and if the RPLMN |

is included in plmn-IdentityList stored in VarLogMeasReport:

| | |
|---|---|
| 3> | if the sigLoggedMeasType in VarLogMeasReport is included: |

| | |
|---|---|
| 4> | include the sigLogMeasConfigAvailable in the |

RRCReestablishmentComplete message and set it according to the following:

| | |
|---|---|
| 5> | if T330 timer is running: |
| | 6> set sigLogMeasConfigAvailable to true in |

the RRCReestablishmentComplete message;

| | |
|---|---|
| 5> | else: |
| | 6> set sigLogMeasConfigAvailable to false in |

the RRCReestablishmentComplete message;

| | |
|---|---|
| 3> | include the logMeasAvailable in the |

RRCReestablishmentComplete message;

| | |
|---|---|
| 3> | if Bluetooth measurement results are included in the logged |

measurements the UE has available for NR:

| | |
|---|---|
| 4> | include the logMeasAvailableBT in the |

RRCReestablishmentComplete message;

| | |
|---|---|
| 3> | if WLAN measurement results are included in the logged |

measurements the UE has available for NR:

| | |
|---|---|
| 4> | include the logMeasAvailableWLAN in the |

RRCReestablishmentComplete message;

| | |
|---|---|
| 2> | if the sigLoggedMeasType in VarLogMeasReport is included: |

| | |
|---|---|
| 3> | if T330 timer is running: |

| | |
|---|---|
| 4> | set sigLogMeasConfigAvailable to true in the |

RRCReestablishmentComplete message;

| | |
|---|---|
| 3> | else: |

| | |
|---|---|
| 4> | if the UE has logged measurements available for NR: |

| | |
|---|---|
| 5> | set sigLogMeasConfigAvailable to false in the |

RRCReestablishmentComplete message;

| | |
|---|---|
| 2> | if the UE has connection establishment failure or connection resume |

failure information available in VarConnEstFailReport or VarConnEstFailReportList and if the
RPLMN is equal to plmn-Identity stored in VarConnEstFailReport or
VarConnEstFailReportList:

| | |
|---|---|
| 3> | include connEstFailInfoAvailable in the |

RRCReestablishmentComplete message;

| | |
|---|---|
| 2> | if the UE has radio link failure or handover failure information available |

in VarRLF-Report and if the RPLMN is included in plmn-IdentityList stored in VarRLF-Report;
or

| | |
|---|---|
| 2> | if the UE has radio link failure or handover failure information available |

in VarRLF-Report of TS 36.331 and if the UE is capable of cross-RAT RLF reporting and if the
RPLMN is included in plmn-IdentityList stored in VarRLF-Report of TS 36.331:

| | |
|---|---|
| 3> | include rlf-InfoAvailable in the RRCReestablishmentComplete |

message;

| | |
|---|---|
| 2> | if the UE has successful handover information available in |

VarSuccessHO-Report and if the RPLMN is included in plmn-IdentityList stored in
VarSuccessHO-Report:

| | |
|---|---|
| 3> | include successHO-InfoAvailable in the |

RRCReestablishmentComplete message;

| | |
|---|---|
| 1> | submit the RRCReestablishmentComplete message to lower layers for |

transmission;

| | |
|---|---|
| 1> | the procedure ends. |

TABLE 8
T311 expiry

| | |
|---|---|
| 5.3.7.6 | T311 expiry |

Upon T311 expiry, the UE may:

| | |
|---|---|
| 1> | if the procedure was initiated due to radio link failure or handover failure: |
| | 2> set the noSuitableCellFound in the VarRLF-Report to true; |
| 1> | perform the actions upon going to RRC_IDLE as specified in 5.3.11, with release |

cause “RRC connection failure.”

TABLE 9
T301 expiry or selected cell no longer suitable

| | |
|---|---|
| 5.3.7.7 | T301 expiry or selected cell no longer suitable |

The UE may:

| | |
|---|---|
| 1> | if timer T301 expires; or |
| 1> | if the selected cell becomes no longer suitable according to the cell selection |

criteria as specified in TS 38.304:

2> perform the actions upon going to RRC_IDLE as specified in 5.3.11, with

release cause “RRC connection failure.”

TABLE 10
Reception of the RRCSetup by the UE

5.3.7.8 Reception of the RRCSetup by the UE
The UE may:

| | |
|---|---|
| 1> | perform the RRC connection establishment procedure as specified in 5.3.3.4. |

TABLES 11A and 11B describe how the UE handles N310, N311 and T310, which specified in 3GPP standard specification.

TABLE 11A
Management of N310 and N311

| | | | When reaching max |
|---|---|---|---|
| | | | value (i.e., configured |
| Counter | Reset | Incremented | N310/N311 value) |
| N310 | Upon reception of “in-sync” | Upon reception of “out- | Start timer T310 |
| | indication from lower layers; | of-sync” from lower | |
| | upon receiving | layer while the timer | |
| | RRCReconfiguration with | T310 is stopped. | |
| | reconfigurationWithSync for | | |
| | that cell group; | | |
| | upon initiating the | | |
| | connection re-establishment | | |
| | procedure. | | |
| N311 | Upon reception of “out-of- | Upon reception of the | Stop the timer T310. |
| | sync” indication from lower | “in-sync” from lower | |
| | layers; | layer while the timer | |
| | upon receiving | T310 is running. | |
| | RRCReconfiguration with | | |
| | reconfigurationWithSync for | | |
| | that cell group; | | |
| | upon initiating the | | |
| | connection re-establishment | | |
| | procedure. | | |

TABLE 11B
Management of T310

| Timer | Start | Stop | At expiry |
|---|---|---|---|
| T310 | Upon detecting | Upon receiving N311 | If the T310 is kept in |
| | physical layer | consecutive in-sync | MCG: If AS security is not |
| | problems for the | indications from lower | activated: go to |
| | SpCell i.e., upon | layers for the SpCell, upon | RRC_IDLE else: initiate |
| | receiving N310 | receiving | the MCG failure |
| | consecutive out-of- | RRCReconfiguration with | information procedure as |
| | sync indications | reconfigurationWithSync | specified in 5.7.3b or the |
| | from lower layers. | for that cell group, upon | connection re- |
| | | reception of | establishment procedure as |
| | | MobilityFromNRCommand, | specified in 5.3.7 or the |
| | | upon the reconfiguration | procedure as specified in |
| | | of rlf-TimersAndConstant, | 5.3.10.3 if any DAPS |
| | | upon initiating the | bearer is configured. |
| | | connection re- | If the T310 is kept in SCG, |
| | | establishment procedure, | Inform E-UTRAN/NR |
| | | upon conditional | about the SCG radio link |
| | | reconfiguration execution | failure by initiating the |
| | | i.e., when applying a | SCG failure information |
| | | stored | procedure as specified in |
| | | RRCReconfiguration | 5.7.3. |
| | | message including | |
| | | reconfigurationWithSync | |
| | | for that cell group, and | |
| | | upon initiating the MCG | |
| | | failure information | |
| | | procedure. | |
| | | Upon SCG release, if the | |
| | | T310 is kept in SCG. | |

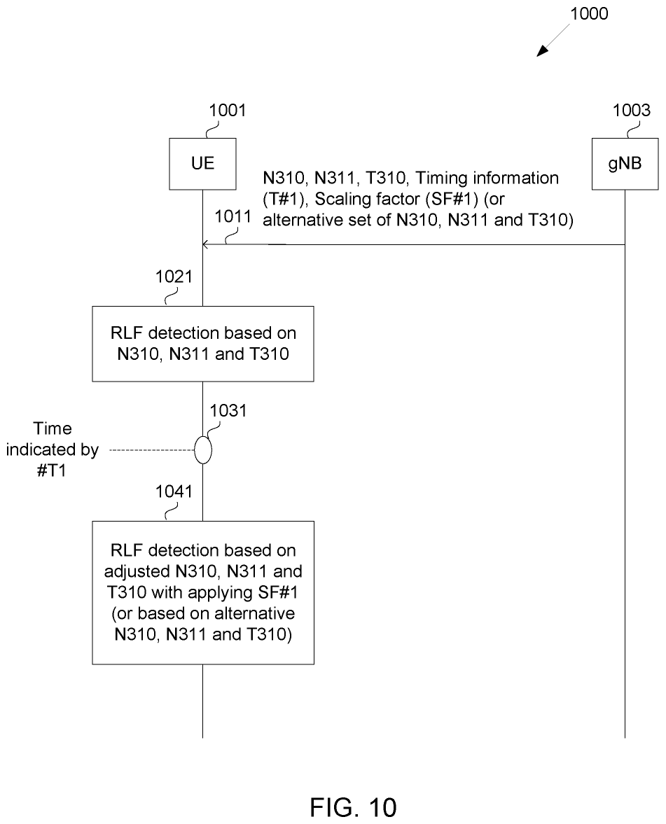

FIG. 10 illustrates signaling flows of an enhanced RLF detection 1000 according to embodiments of the present disclosure. The enhanced RLF detection 1000 as may be performed by a UE (e.g., 111-116 as illustrated in FIG. 1) and a base station (e.g., 101-103 as illustrated in FIG. 1). An embodiment of the enhanced RLF detection 1000 shown in FIG. 10 is for illustration only. One or more of the components illustrated in FIG. 10 can be implemented in specialized circuitry configured to perform the noted functions or one or more of the components can be implemented by one or more processors executing instructions to perform the noted functions.

FIG. 10 describes one example of signalling flow for an enhanced radio link failure detection in NTN. 1001 indicates an NTN UE in an RRC connected state and 1003 indicates a serving gNB of 1001 UE. The gNB configures the value of N310, N311, T310, timing information (T #1) and/or scaling factor (SF #1) (or alternative value of N310, N311 and T310) to the UE (1011). This configuration can be transmitted by either UE dedicated RRC message (e.g., RRCReconfiguration message) or system information block.

In another example, some configuration (e.g., N310, N311 and T310) can be transmitted by UE dedicated RRC message and other configuration (e.g., T #1 and/or SF #1 (or alternative value of N310, N311 and T310)) can be transmitted by system information block. In another example, some configuration (e.g. SF #1) can be fixed value defined in the specification. Once 1011 is configured, the UE performs RLF detection based on the signalled N310, N311 and T310 from 1011 if the (measured) current time is before the time indicated by T #1 (1021). If the (measured) current time is (equal to or) after the time indicated by T #1 (1031 or after 1031), the UE performs RLF detection based on adjusted N310, N311 and/or T310 with applying SF #1 to the signalled N310, N311 and/or T310 from 911 (1041).

For example, adjusted N310, N311 and T310 can be derived from {N310*SF #1, N311*SF #1, and/or T310*SF #1}. If SF #1 is configured as “0” in 1011, the UE can immediately decide RLF is detected if T310 runs (or the condition to start T310 is met). Here it is assumed SF #1 is commonly applied to N310, N311 and T310. As another example, SF #1 can be applied to one or two of them (e.g. SF #1 is applied only to T310). As another example, 1011 can configure separate SF value, for example SF #1 for N310, SF #2 for N311 and SF #3 for T310. In the case, adjusted N310, N311 and T310 can be derived from {N310*SF #1, N311*SF #2, and/or T310*SF #3}. If instead of SF #1, alternative set of N310, N311 and/or T310 are configured in 1011, the UE performs RLF detection based on alternative N310, N311 and/or T310 if the (measured) current time is (equal to or) after the time indicated by T #1. Note if the (measured) current time is before the time indicated by T #1, the UE performs RLF detection based on the first set of N310, N311 and/or T310 from 1011.

With the enhanced RLF detection, the UE can quickly detect RLF (assuming SF #1 is configured to make the adjusted N310, N311 and T310 be smaller or alternative set of N310, N311 and T310 are configured with smaller values compared to the first set of N310, N311 and T310 from 1011) once the serving satellite stops the service on the cell location on the earth at a specific time (assuming a time indicated by T #1) because the UE moves away and new incoming satellite replace the service there.

Note if the UE still stays in the cell provided by disappearing satellite without handover to the new incoming satellite (or new incoming serving cell) after the specific time, the radio link between the UE and the satellite may be most likely failed/broken (especially when the UE is in the cell location centre). For the current time and T #1, absolute time in a format of YY-MM-DD HH:MM:SS (with BCD encoding) can be used. As another example, absolute time in a format of numbers of time unit (e.g., 10 ms) after some reference timing (e.g., 00:00:00 on Gregorian calendar date 1 Jan. 1900) can be used. As another example, T #1 can be signalled as a timer value. In the case, the UE starts the timer when 1011 is configured/received, performs 1021 before the timer expires and 1041 after the timer expires.

In the figure, RLF detection based on N310, N311 and T310 is assumed. As another example, the provided embodiment can be also applied to RLF detection based on the indication from source MCG RLC that the maximum number of retransmissions has been reached. In the case, a maximum number of RLC retransmissions, T #1, and SF #1 (or alternative set of a maximum number of RLC retransmissions) are configured in 1011. The UE performs RLF detection based on the configured maximum number of RLC retransmissions if the (measured) current time is before the time indicated by T #1, and performs RLF detection based on adjusted maximum number of RLC retransmissions with applying SF #1, e.g., adjusted maximum number of RLC retransmissions=the configured maximum number of RLC retransmissions*SF #1, (or performs RLF detection based on alternative N310, N311 and T310 if alternative ones are configured instead of SF #1) if the current time is (equal to or) after the time indicated by T #1.

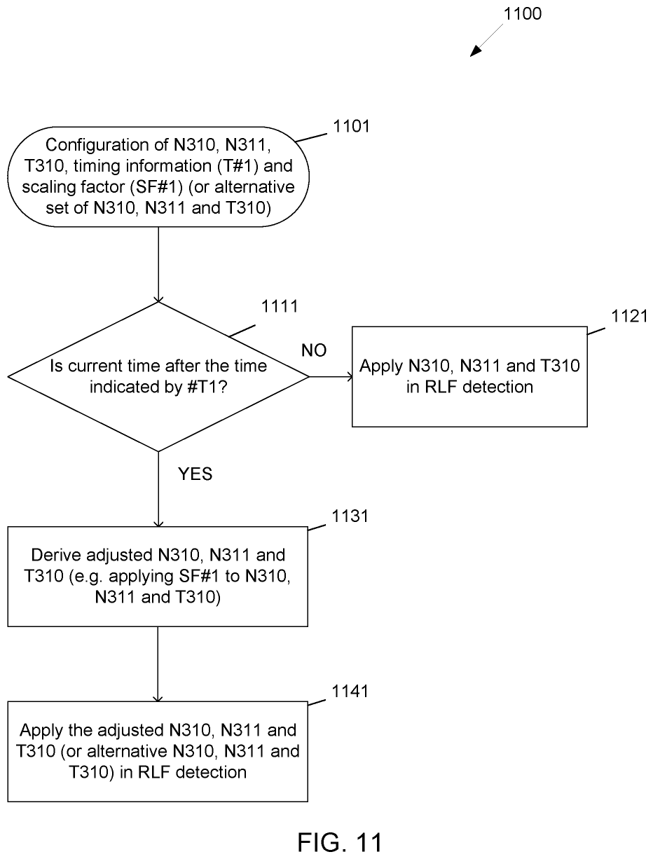

FIG. 11 illustrates a flowchart of UE operation 1100 for an enhanced RLF detection according to embodiments of the present disclosure. The UE operation 1100 as may be performed by a UE (e.g., 111-116 as illustrated in FIG. 1). An embodiment of the UE operation 1100 shown in FIG. 11 is for illustration only. One or more of the components illustrated in FIG. 11 can be implemented in specialized circuitry configured to perform the noted functions or one or more of the components can be implemented by one or more processors executing instructions to perform the noted functions.

FIG. 11 describes one example of UE operation flows according to the example in FIG. 10. The UE is configured with N310, N311, T310, timing information (T #1) and/or scaling factor (SF #1) (or alternative set of N310, N311, and T310) (1101). The UE checks if the (measured) current time is (equal to or) after the time indicated by T #1 (1111). If the current time is before the time indicated by T #1, the UE applies the configured N310, N311, and T310 from 1101 (or the configured first set of N310, N311, and T310 if alternative set of N310, N311, and T310 are also configured in 1101) in RLF detection (1121). If the current time is (equal to or) after the time indicated by T #1, the UE derives adjusted N310, N311, and/or T310 with applying SF #1 (e.g., adjusted N310, N311, and/or T310 are {N310*SF #1, N311*SF #1, and/or T310*SF #1} (1131) and applies the adjusted N310, N311, and/or T310 in RLF detection (1141). If instead of SF #1, alternative set of N310, N311, and/or T310 are configured in 1101, the UE does not perform 1131 and in 1141, applies alternative N310, N311, and/or T310 in RLF detection.

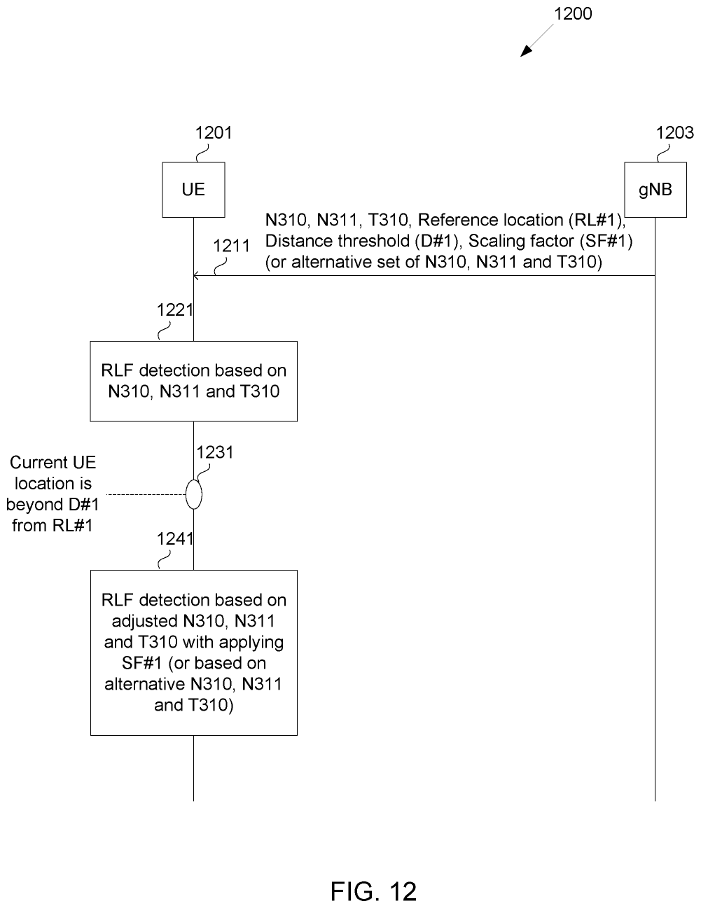

FIG. 12 illustrates signaling flows of an enhanced RLF detection 1200 according to embodiments of the present disclosure. The enhanced RLF detection 1200 as may be performed by a UE (e.g., 111-116 as illustrated in FIG. 1) and a base station (e.g., 101-103 as illustrated in FIG. 1). An embodiment of the enhanced RLF detection 1200 shown in FIG. 12 is for illustration only. One or more of the components illustrated in FIG. 12 can be implemented in specialized circuitry configured to perform the noted functions or one or more of the components can be implemented by one or more processors executing instructions to perform the noted functions.

FIG. 12 describes another example of signalling flow for an enhanced radio link failure detection in NTN. 1201 indicates an NTN UE in an RRC connected state and 1203 indicates a serving gNB of 1201 UE. The gNB configures the value of N310, N311, and T310, reference location (RL #1), distance threshold (D #1) and/or scaling factor (SF #1) (or alternative value of N310, N311 and T310) to the UE (1211). This configuration can be transmitted by either UE dedicated RRC message (e.g., RRCReconfiguration message) or system information block.

In another example, some configuration (e.g., N310, N311, and T310) can be transmitted by UE dedicated RRC message and other configuration (e.g., RL #1, D #1 and/or SF #1 (or alternative value of N310, N311 and T310)) can be transmitted by system information block. In another example, some configuration (e.g. SF #1) can be fixed value defined in the specification. Once 1211 is configured, the UE derives its current UE location (e.g., based on GNSS-based positioning) and calculates the distance between the current UE location and the reference location indicated by RL #1. If the calculated distance is smaller than D #1, the UE performs RLF detection based on the signalled N310, N311, and T310 from 1111 (1221). If the calculated distance is (equal to or) larger than D #1 (1231), the UE performs RLF detection based on adjusted N310, N311, and/or T310 with applying SF #1 to the signalled N310, N311 and/or T310 from 1111 (1241).

For example, adjusted N310, N311, and T310 can be derived from {N310*SF #1, N311*SF #1, and/or T310*SF #1}. If SF #1 is configured as “0” in 1111, the UE can immediately decide RLF is detected if T310 runs (or the condition to start T310 is met). Here it is assumed SF #1 is commonly applied to N310, N311, and T310. As another example, SF #1 can be applied to one or two of them (e.g. SF #1 is applied only to T310). As another example, 1211 can configure separate SF value, for example SF #1 for N310, SF #2 for N311 and/or SF #3 for T310. In the case, adjusted N310, N311, and/or T310 can be derived from {N310*SF #1, N311*SF #2, and/or T310*SF #3}. If instead of SF #1, alternative set of N310, N311, and/or T310 are configured in 1211, the UE performs RLF detection based on alternative N310, N311, and/or T310 if the calculated distance is (equal to or) larger than D #1.

Note if the calculated distance is smaller than D #1, the UE performs RLF detection based on the first set of N310, N311, and T310 from 1211. With the enhanced RLF detection, the UE can quickly detect RLF (assuming SF #1 is configured to make the adjusted N310, N311 and/or T310 be smaller or alternative set of N310, N311, and/or T310 are configured with smaller values compared to the first set of N310, N311, and T310 from 1211) when the UE location is far away from the cell location on the earth that a serving satellite can serve (assuming the UE cannot be served/reached good enough if the UE's location is far beyond D #1 from RL #1). In the case, the radio link between the UE and the satellite may be most likely failed/broken.

For the current UE location and RL #1, a geo-location coordinate {X, Y} or {X, Y, Z} can be used, where X is latitude information, Y is longitude information and Z is altitude information. Details of location coordinates are specified in 3GPP standard specification.

In figure, RLF detection based on N310, N311, and T310 is assumed. As another example, the provided embodiment can be also applied to RLF detection based on the indication from source MCG RLC that the maximum number of retransmissions has been reached. In the case, a maximum number of RLC retransmissions, RL #1, D #1, and SF #1 (or alternative set of a maximum number of RLC retransmissions) are configured in 1111. The UE performs RLF detection based on the configured maximum number of RLC retransmissions if the calculated distance is smaller than D #1, and performs RLF detection based on adjusted maximum number of RLC retransmissions with applying SF #1 (e.g., adjusted maximum number of RLC retransmissions=the configured maximum number of RLC retransmissions*SF #1) (or performs RLF detection based on the alternative maximum number of RLC retransmissions if alternative one is configured instead of SF #1) if the calculated distance is (equal to or) larger than D #1.

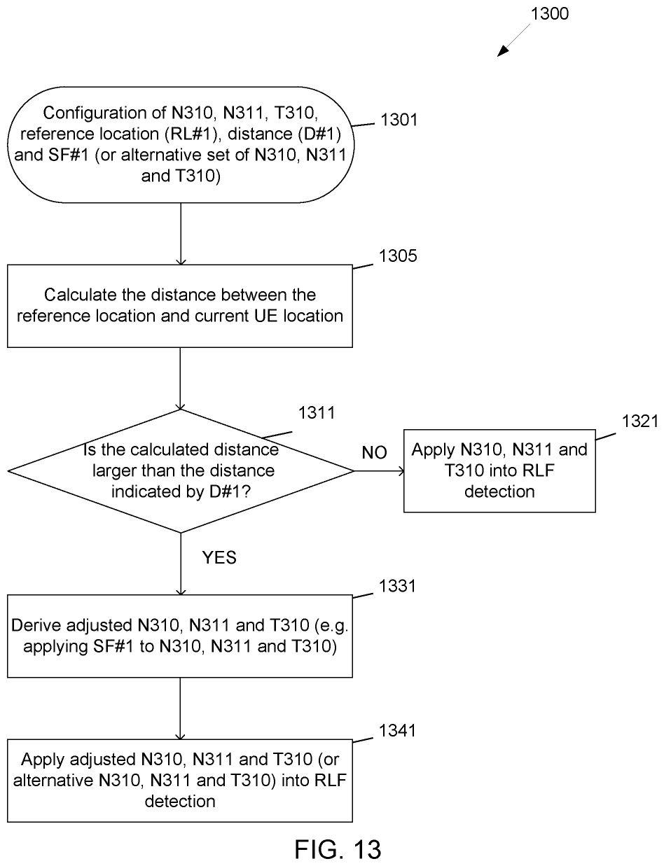

FIG. 13 illustrates a flowchart of UE operation 1300 for an enhanced RLF detection according to embodiments of the present disclosure. The UE operation 1300 as may be performed by a UE (e.g., 111-116 as illustrated in FIG. 1). An embodiment of the UE operation 1300 shown in FIG. 13 is for illustration only. One or more of the components illustrated in FIG. 13 can be implemented in specialized circuitry configured to perform the noted functions or one or more of the components can be implemented by one or more processors executing instructions to perform the noted functions.

FIG. 13 describes one example of UE operation flows according to the example in FIG. 11. The UE is configured with N310, N311, T310, reference location (RL #1), distance threshold (D #1), and/or scaling factor (SF #1) (or alternative set of N310, N311, and/or T310) (1301). The UE calculates the distance between the reference location and the current UE location (e.g., derived from GNSS-based positioning) (1305). The UE checks if the calculated distance is (equal to or) larger than the distance indicated by D #1 (1311). If the calculated distance is smaller than the distance indicated by D #1, the UE applies the configured N310, N311, and T310 from 1301 (or the configured first set of N310, N311, and T310 if alternative set of N310, N311, and T310 are also configured in 1301) in RLF detection (1321).

If the calculated distance is (equal to or) larger than the distance indicated by D #1, the UE derives adjusted N310, N311, and T310 with applying SF #1 (e.g., adjusted N310, N311 and/or T310 are {N310*SF #1, N311*SF #1, and/or T310*SF #1} (1331) and applies the adjusted N310, N311, and/or T310 in RLF detection (1341). If instead of SF #1, alternative set of N310, N311 and/or T310 are configured in 1301, the UE does not perform 1331 and in 1341, applies alternative N310, N311, and/or T310 in RLF detection.

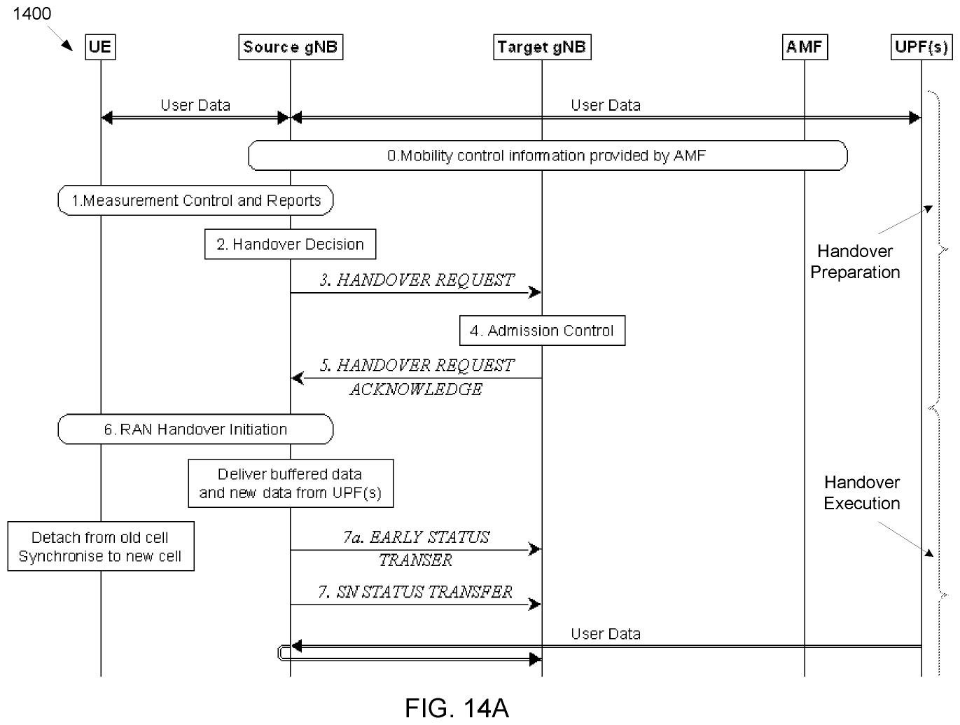

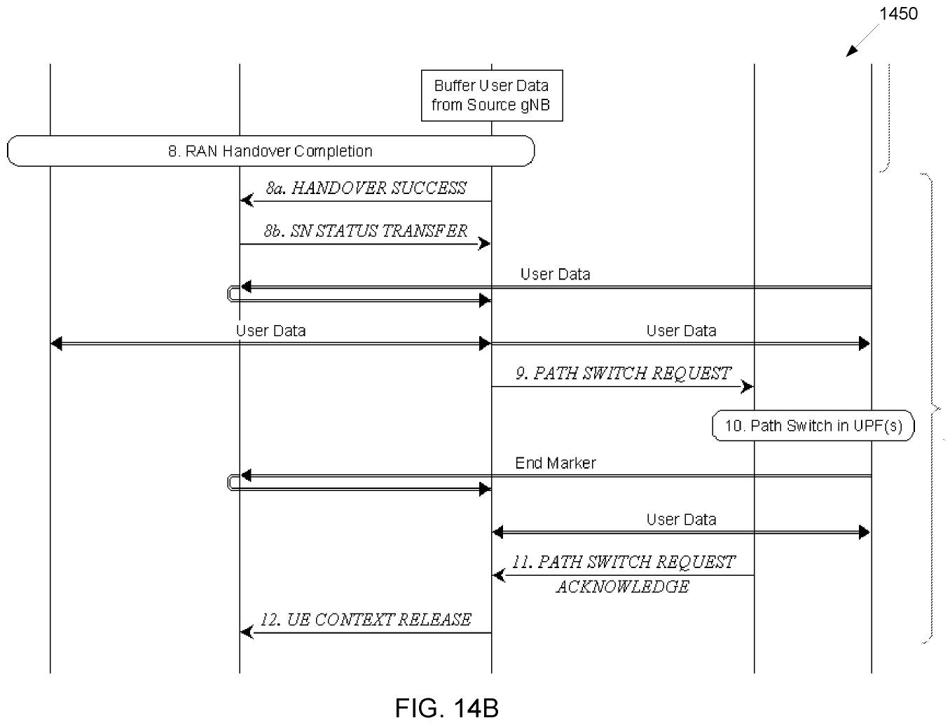

FIG. 14A illustrates signaling flows of basic HO 1400 according to embodiments of the present disclosure. The HO 1400 as may be performed by a UE (e.g., 111-116 as illustrated in FIG. 1) and a base station (e.g., 101-103 as illustrated in FIG. 1). An embodiment of the HO 1400 shown in FIG. 14A is for illustration only. One or more of the components illustrated in FIG. 14A can be implemented in specialized circuitry configured to perform the noted functions or one or more of the components can be implemented by one or more processors executing instructions to perform the noted functions.

FIG. 14B illustrates signaling flows of basic HO 1450 according to embodiments of the present disclosure. The HO 1450 as may be performed by a UE (e.g., 111-116 as illustrated in FIG. 1) and a base station (e.g., 101-103 as illustrated in FIG. 1). An embodiment of the HO 1450 shown in FIG. 14B is for illustration only. One or more of the components illustrated in FIG. 14B can be implemented in specialized circuitry configured to perform the noted functions or one or more of the components can be implemented by one or more processors executing instructions to perform the noted functions. FIGS. 14A and 14B are connected together.

FIGS. 14A and 14B describe an example of basic HO mechanism. The intra-NR RAN handover performs the preparation and execution phase of the handover procedure performed without involvement of the 5GC, i.e., preparation messages are directly exchanged between the gNB s. The release of the resources at the source gNB during the handover completion phase is triggered by the target gNB. The figure below depicts the basic handover scenario where neither the AMF nor the UPF changes.

In step 0, the UE context within the source gNB contains information regarding roaming and access restrictions which were provided either at connection establishment or at the last TA update.

In step 1, the source gNB configures the UE measurement procedures and the UE reports according to the measurement configuration.

In step 2, the source gNB decides to handover the UE, based on MeasurementReport and RRM information.

In step 3, the source gNB issues a handover request message to the target gNB passing a transparent RRC container with necessary information to prepare the handover at the target side. The information includes at least the target cell ID, KgNB*, the C-RNTI of the UE in the source gNB, RRM-configuration including UE inactive time, basic AS-configuration including antenna Info and DL Carrier Frequency, the current QoS flow to DRB mapping rules applied to the UE, the SIB1 from the source gNB, the UE capabilities for different RATs, PDU session related information, and can include the UE reported measurement information including beam-related information if available. The PDU session related information includes the slice information and QoS flow level QoS profile(s). The source gNB may also request a DAPS handover for one or more DRBs.

It is noted that after issuing a handover request, the source gNB may not reconfigure the UE, including performing Reflective QoS flow to DRB mapping.

In step 4, an admission control may be performed by the target gNB. Slice-aware admission control may be performed if the slice information is sent to the target gNB. If the PDU sessions are associated with non-supported slices the target gNB may reject such PDU Sessions.

In step 5, the target gNB prepares the handover with L1/L2 and sends the HANDOVER REQUEST ACKNOWLEDGE to the source gNB, which includes a transparent container to be sent to the UE as an RRC message to perform the handover. The target gNB also indicates if a DAPS handover is accepted.

It is noted that as soon as the source gNB receives the HANDOVER REQUEST ACKNOWLEDGE, or as soon as the transmission of the handover command is initiated in the downlink, data forwarding may be initiated.

It is noted that, for DRBs configured with DAPS, downlink PDCP SDUs are forwarded with SN assigned by the source gNB, until SN assignment is handed over to the target gNB in step 8b, for which the normal data forwarding follows as defined in 3GPP standard specification.

In step 6, the source gNB triggers the Uu handover by sending an RRCReconfiguration message to the UE, containing the information required to access the target cell: at least the target cell ID, the new C-RNTI, the target gNB security algorithm identifiers for the selected security algorithms. It can also include a set of dedicated RACH resources, the association between RACH resources and SSB(s), the association between RACH resources and UE-specific CSI-RS configuration(s), common RACH resources, and system information of the target cell, etc.

It is noted that, for DRBs configured with DAPS, the source gNB does not stop transmitting downlink packets until the gNB receives the HANDOVER SUCCESS message from the target gNB in step 8a.

It is noted that CHO cannot be configured simultaneously with DAPS handover.

In step 7a, for DRBs configured with DAPS, the source gNB sends the EARLY STATUS TRANSFER message. The DL COUNT value conveyed in the EARLY STATUS TRANSFER message indicates PDCP SN and HFN of the first PDCP SDU that the source gNB forwards to the target gNB. The source gNB does not stop assigning SNs to downlink PDCP SDUs until the gNB sends the SN STATUS TRANSFER message to the target gNB in step 8b.

In step 7, for DRBs not configured with DAPS, the source gNB sends the SN STATUS TRANSFER message to the target gNB to convey the uplink PDCP SN receiver status and the downlink PDCP SN transmitter status of DRBs for which PDCP status preservation applies (i.e., for RLC AM). The uplink PDCP SN receiver status includes at least the PDCP SN of the first missing UL PDCP SDU and may include a bit map of the receive status of the out of sequence UL PDCP SDUs that the UE needs to retransmit in the target cell, if any. The downlink PDCP SN transmitter status indicates the next PDCP SN that the target gNB may assign to new PDCP SDUs, not having a PDCP SN yet.

It is noted that, in case of DAPS handover, the uplink PDCP SN receiver status and the downlink PDCP SN transmitter status for a DRB with RLC-AM and not configured with DAPS may be transferred by the SN STATUS TRANSFER message in step 8b instead of step 7.

It is noted that for DRBs configured with DAPS, the source gNB may additionally send the EARLY STATUS TRANSFER message(s) between step 7 and step 8b, to inform discarding of already forwarded PDCP SDUs. The target gNB does not transmit forwarded downlink PDCP SDUs to the UE, whose COUNT is less than the conveyed DL COUNT value and discards them if transmission has not been attempted already.

In step 8, the UE synchronizes to the target cell and completes the RRC handover procedure by sending RRCReconfigurationComplete message to target gNB. In case of DAPS handover, the UE does not detach from the source cell upon receiving the RRCReconfiguration message. The UE releases the source resources and configurations and stops DL/UL reception/transmission with the source upon receiving an explicit release from the target node.

In step 6a, from RAN point of view, the DAPS handover is considered to only be completed after the UE has released the source cell as explicitly requested from the target node. RRC suspend, a subsequent handover or inter-RAT handover cannot be initiated until the source cell has been released.

In step 8a/b, in case of DAPS handover, the target gNB sends the HANDOVER SUCCESS message to the source gNB to inform that the UE has successfully accessed the target cell. In return, the source gNB sends the SN STATUS TRANSFER message for DRBs configured with DAPS for which the description in step 7 applies, and the normal data forwarding follows as defined in 3GPP standard specification.

It is noted that the uplink PDCP SN receiver status and the downlink PDCP SN transmitter status are also conveyed for DRBs with RLC-UM in the SN STATUS TRANSFER message in step 8b, if configured with DAPS.

It is noted that, for DRBs configured with DAPS, the source gNB does not stop delivering uplink QoS flows to the UPF until the gNB sends the SN STATUS TRANSFER message in step 8b. The target gNB does not forward QoS flows of the uplink PDCP SDUs successfully received in-sequence to the UPF until the gNB receives the SN STATUS TRANSFER message, in which UL HFN and the first missing SN in the uplink PDCP SN receiver status indicates the start of uplink PDCP SDUs to be delivered to the UPF. The target gNB does not deliver any uplink PDCP SDUs which has an UL COUNT lower than the provided. It is noted that it is void.

In step 9, the target gNB sends a PATH SWITCH REQUEST message to AMF to trigger 5GC to switch the DL data path towards the target gNB and to establish an NG-C interface instance towards the target gNB.

In step 10, a 5GC switches the DL data path towards the target gNB. The UPF sends one or more “end marker” packets on the old path to the source gNB per PDU session/tunnel and then can release any U-plane/TNL resources towards the source gNB.

In step 11, the AMF confirms the PATH SWITCH REQUEST message with the PATH SWITCH REQUEST ACKNOWLEDGE message.

In step 12, upon reception of the PATH SWITCH REQUEST ACKNOWLEDGE message from the AMF, the target gNB sends the UE CONTEXT RELEASE to inform the source gNB about the success of the handover. The source gNB can then release radio and C-plane related resources associated to the UE context. Any ongoing data forwarding may continue.

The RRM configuration can include both beam measurement information (for layer 3 mobility) associated to SSB(s) and CSI-RS(s) for the reported cell(s) if both types of measurements are available. Also, if CA is configured, the RRM configuration can include the list of best cells on each frequency for which measurement information is available. And the RRM measurement information can also include the beam measurement for the listed cells that belong to the target gNB.

The common RACH configuration for beams in the target cell is only associated to the SSB(s). The network can have dedicated RACH configurations associated to the SSB(s) and/or have dedicated RACH configurations associated to CSI-RS(s) within a cell. The target gNB can only include one of the following RACH configurations in the handover command to enable the UE to access the target cell: (1) a common RACH configuration; (2) a common RACH configuration and a dedicated RACH configuration associated with SSB; and (3) a common RACH configuration and a dedicated RACH configuration associated with CSI-RS.

The dedicated RACH configuration allocates RACH resource(s) together with a quality threshold to use them. When dedicated RACH resources are provided, they are prioritized by the UE and the UE may not switch to contention-based RACH resources as long as the quality threshold of those dedicated resources is met. The order to access the dedicated RACH resources is up to UE implementation.

Upon receiving a handover command requesting DAPS handover, the UE suspends source cell SRBs, stops sending and receiving any RRC control plane signaling toward the source cell, and establishes SRBs for the target cell. The UE releases the source cell SRBs configuration upon receiving source cell release indication from the target cell after successful DAPS handover execution. When DAPS handover to the target cell fails and if the source cell link is available, then the UE reverts back to the source cell configuration and resumes source cell SRBs for control plane signaling transmission.

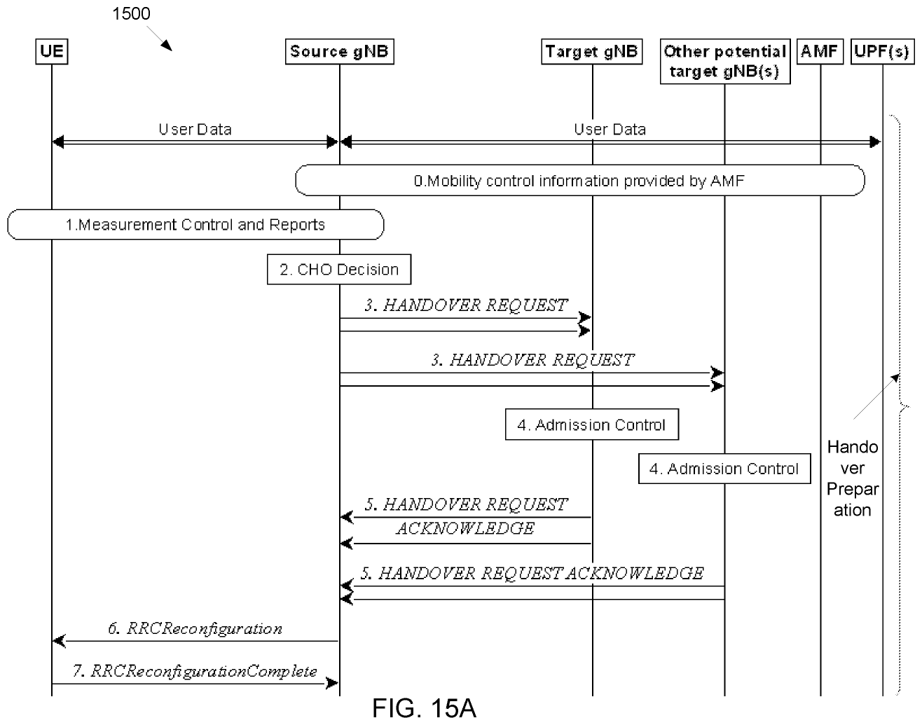

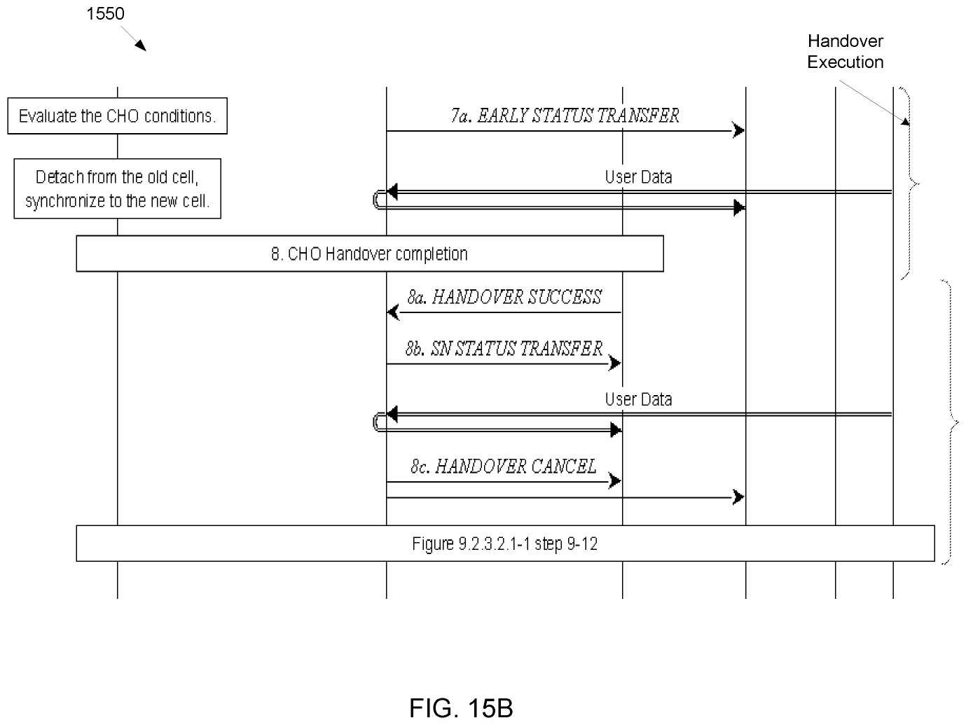

FIG. 15A illustrates signaling flows of basic CHO 1500 according to embodiments of the present disclosure. The basic CHO 1500 as may be performed by a UE (e.g., 111-116 as illustrated in FIG. 1) and a base station (e.g., 101-103 as illustrated in FIG. 1). An embodiment of the basic CHO 1500 shown in FIG. 15A is for illustration only. One or more of the components illustrated in FIG. 15A can be implemented in specialized circuitry configured to perform the noted functions or one or more of the components can be implemented by one or more processors executing instructions to perform the noted functions.

FIG. 15B illustrates signaling flows of basic CHO 1550 according to embodiments of the present disclosure. The basic CHO 1550 as may be performed by a UE (e.g., 111-116 as illustrated in FIG. 1) and a base station (e.g., 101-103 as illustrated in FIG. 1). An embodiment of the basic CHO 1550 shown in FIG. 15B is for illustration only. One or more of the components illustrated in FIG. 15B can be implemented in specialized circuitry configured to perform the noted functions or one or more of the components can be implemented by one or more processors executing instructions to perform the noted functions. FIGS. 15A and 15B are connected together.

FIGS. 15A and 15 B describe an example of conditional HO mechanism. A conditional handover (CHO) is defined as a handover that is executed by the UE when one or more handover execution conditions are met. The UE starts evaluating the execution condition(s) upon receiving the CHO configuration, and stops evaluating the execution condition(s) once a handover is executed.

The following principles apply to CHO: (1) the CHO configuration contains the configuration of CHO candidate cell(s) generated by the candidate gNB(s) and execution condition(s) generated by the source gNB; (2) an execution condition may comprise one or two trigger condition(s) (CHO events A3/A5, as defined in 3GPP standard specification). Only single RS type is supported and at most two different trigger quantities (e.g., RSRP and RSRQ, RSRP and SINR, etc.) can be configured simultaneously for the evalution of CHO execution condition of a single candidate cell; (3) before any CHO execution condition is satisfied, upon reception of HO command (without CHO configuration), the UE executes the HO procedure as described in 3GPP standard specification regardless of any previously received CHO configuration; and (4) while executing CHO, i.e., from the time when the UE starts synchronization with target cell, UE does not monitor source cell.

CHO is also supported for the IAB-MT in context of intra- and inter-donor IAB-node migration and BH RLF recovery. CHO is not supported for NG-C based handover in this release of the specification. As illustrated in FIGS. 15A and 15B, steps 0 and 1 are same as the steps and 1 as illustrated in FIGS. 14A and 14B.

In step 2, the source gNB decides to use CHO.

In step 3, the source gNB requests CHO for one or more candidate cells belonging to one or more candidate gNBs. A CHO request message is sent for each candidate cell.

In step 4, this step is same as step 4 in FIGS. 14A and 14B.

In step 5, the candidate gNB(s) sends CHO response (HO REQUEST ACKNOWLEDGE) including configuration of CHO candidate cell(s) to the source gNB. The CHO response message is sent for each candidate cell.

In step 6, the source gNB sends an RRCReconfiguration message to the UE, containing the configuration of CHO candidate cell(s) and CHO execution condition(s).

It is noted that CHO configuration of candidate cells can be followed by other reconfiguration from the source gNB.

It is noted that a configuration of a CHO candidate cell cannot contain a DAPS handover configuration.

In step 7, the UE sends an RRCReconfigurationComplete message to the source gNB.

In step 7a, if early data forwarding is applied, the source gNB sends the EARLY STATUS TRANSFER message.

In step 8, the UE maintains connection with the source gNB after receiving CHO configuration, and starts evaluating the CHO execution conditions for the candidate cell(s). If at least one CHO candidate cell satisfies the corresponding CHO execution condition, the UE detaches from the source gNB, applies the stored corresponding configuration for that selected candidate cell, synchronizes to that candidate cell and completes the RRC handover procedure by sending RRCReconfigurationComplete message to the target gNB. The UE releases stored CHO configurations after successful completion of RRC handover procedure.

In step 8a/b, the target gNB sends the HANDOVER SUCCESS message to the source gNB to inform that the UE has successfully accessed the target cell. In return, the source gNB sends the SN STATUS TRANSFER message following the principles described in step 7 of intra-AMF/UPF handover in FIGS. 14A and 14B.

It is noted that late data forwarding may be initiated as soon as the source gNB receives the HANDOVER SUCCESS message.

In step 8c, the source gNB sends the HANDOVER CANCEL message toward the other signalling connections or other candidate target gNBs, if any, to cancel CHO for the UE.

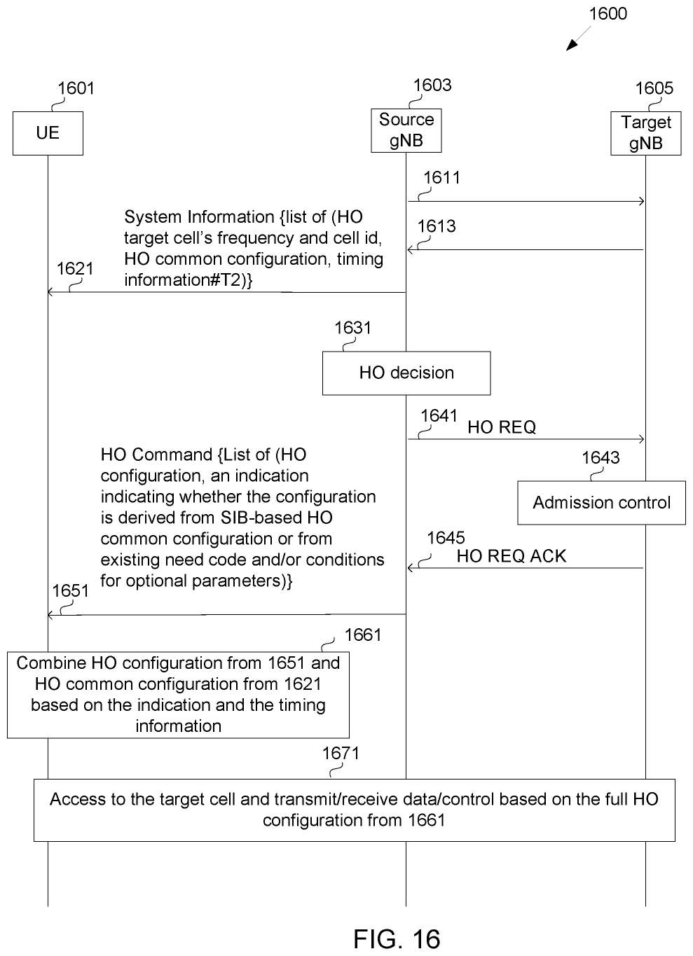

FIG. 16 illustrates signaling flows of an enhanced HO 1600 according to embodiments of the present disclosure. The enhanced HO 1600 as may be performed by a UE (e.g., 111-116 as illustrated in FIG. 1) and a base station (e.g., 101-103 as illustrated in FIG. 1). An embodiment of the enhanced HO 1600 shown in FIG. 16 is for illustration only. One or more of the components illustrated in FIG. 16 can be implemented in specialized circuitry configured to perform the noted functions or one or more of the components can be implemented by one or more processors executing instructions to perform the noted functions.

FIG. 16 describes an example of signaling flow for an enhanced HO in NTN. 1601 indicates a UE in an RRC connected state, 1603 indicates a serving gNB that handles the serving cell before HO and 1605 indicates a target gNB that handles a target cell for HO. 1603 source gNB transmits HO common configuration request (REQ) to 1605 target gNB (1611). The gNB requests HO common configuration that needs to be valid (or maintained by the target gNB) until the time indicated by timing information #T1 to the target gNB.

The source gNB can also include the estimated number of UEs for HO until the time indicated by T1 and the target gNB takes the number of UEs into account to set appropriate HO common configurations. Once the target gNB sets the HO common configurations, the gNB transmits HO common configuration response (RES) to the source gNB (1613). It includes the HO common configurations that is valid (or maintained by the target gNB) until the time indicated by timing information #T2. For example, HO common configurations include configuration(s) of common radio channel, common parameter(s) of dedicated channel, common value of counter(s) and timer(s), common parameter(s) of MAC/RLC/RRC/PDCP sub-layers, configuration transmitted via system information in the target cell, and so forth. The HO common configurations can be commonly applied to all UEs for HO before the time indicated by T2. Note T2 can be different compared to T1 from 1611.

Then the source gNB transmits the received HO common configurations and timing information ##T2 with the HO target cell information via system information (1621). HO target cell information includes the target cell's frequency information and cell id, e.g., physical cell id. 1621 can include multiple of HO target cell's HO common configurations and its associated timing information #T2. Note each HO target cell's associated T2 can be different. Timing information T1 and/or T2 can be absolute time in a format of YY-MM-DD HH:MM:SS (with BCD encoding).

In another example, T1 and/or T2 can be absolute time in a format of numbers of time unit (e.g., 10 ms) after some reference timing (e.g., 00:00:00 on Gregorian calendar date 1 Jan. 1900). As another example, T1 and/or T2 can be signalled as a timer value. In the case, the UE starts the timer when the UE is configured/received. Also note the system information is broadcasted in a cell. If the source gNB decides to handover 1601 UE to the target cell that is handled by the target gNB (1631), the gNB transmits HO REQ to the target gNB (1641). The source gNB issues a HO REQ message to the target gNB passing a transparent RRC container with necessary information to prepare the handover at the target side.

The information includes at least the target cell ID, KgNB*, the C-RNTI of the UE in the source gNB, RRM-configuration including UE inactive time, basic AS-configuration including antenna Info and DL Carrier Frequency, the current QoS flow to DRB mapping rules applied to the UE, the SIB1 from source gNB, the UE capabilities for different RATs, PDU session related information, and can include the UE reported measurement information including beam-related information if available. The PDU session related information includes the slice information and QoS flow level QoS profile(s). The source gNB may also request a DAPS handover for one or more DRB s.

An admission control may be performed by the target gNB (1643). A slice-aware admission control may be performed if the slice information is sent to the target gNB. If the PDU sessions are associated with non-supported slices the target gNB may reject such PDU Sessions. The target gNB prepares the handover with L1/L2 and sends the HO REQ ACKNOWLEDGE (ACK) to the source gNB (1645), which includes a transparent container to be sent to the UE as an RRC message to perform the handover. The target gNB also indicates if a DAPS handover is accepted. The source gNB transmits HO command (RRC reconfiguration message indicating HO), containing the information/parameter(s) required to access the target and to transmit and/or receive data and/or control signal (here each information/parameter or set of information/parameters or full information/parameters is called as a HO configuration), to the UE (1651).

For example, the target cell id, the new C-RNTI, the target gNB security algorithm identifier for the selected security algorithms. It can also include a set of radio channel (e.g., RACH, PDCCH, PDSCH, PUCCH, PUSCH, etc.) resources and related parameters, a set of reference signal (SSB(s), CSI-RS, DMRS, UL RS, SRS, etc.) resources and related parameters, a set of timers, constants and variables for PHY/MAC/RLC/RRC/PDCP operations, and system information of the target cell, etc. A HO configuration can include an indication indicating whether the configuration is derived from SIB-based HO common configuration or from the existing need code and/or conditions defined in 3GPP standard specification for the optional information/parameter.

Existing need code and/or conditions for optional information/parameter are specified as shown in examples.

In one example, as illustrated in 3GPP standard specification, the need for fields to be present in a message or an abstract type, i.e., the ASN.1 fields that are specified as OPTIONAL in the abstract notation (ASN.1), is specified by means of comment text tags attached to the OPTIONAL statement in the abstract syntax. All comment text tags are available for use in the downlink direction only. The meaning of each tag is specified in 3GPP standard specification.

If conditions are used, a conditional presence table is provided for the message or information element specifying the need of the field for each condition case. The table also specifies whether UE maintains or releases the value in case the field is absent. The conditions clarify what the UE may expect regarding the setting of the message by the network. Violation of conditions is regarded as invalid network behavior, which the UE is not required to cope with. Hence the general error handling defined in 3GPP standard specification does not apply in case a field is absent although it is mandatory according to the CondC or CondM condition.

TABLE 12 shows guidelines on the use of need codes and conditions.

TABLE 12
Meaning of abbreviations used to specify the need for fields to be present

| Abbreviation | Meaning |
|---|---|
| Cond | Conditionally present |
| conditionTag | Presence of the field is specified in a tabular form following the ASN.1 |
| | segment. |
| CondC | Configuration condition |
| conditionTag | Presence of the field is conditional to other configuration settings. |
| CondM | Message condition |
| conditionTag | Presence of the field is conditional to other fields included in the message. |
| Need S | Specified |
| | Used for (configuration) fields, whose field description or procedure specifies |
| | the UE behavior performed upon receiving a message with the field absent |
| | (and not if field description or procedure specifies the UE behavior when field |
| | is not configured). |
| Need M | Maintain |
| | Used for (configuration) fields that are stored by the UE i.e., not one-shot. |
| | Upon receiving a message with the field absent, the UE maintains the current |
| | value. |
| Need N | No action (one-shot configuration that is not maintained) |
| | Used for (configuration) fields that are not stored and whose presence causes |
| | a one-time action by the UE. Upon receiving message with the field absent, |
| | the UE takes no action. |
| Need R | Release |
| | Used for (configuration) fields that are stored by the UE i.e., not one-shot. |
| | Upon receiving a message with the field absent, the UE releases the current |
| | value. |

In one example, the condition tags CondC and CondM may not be used.

Any field with Need M or Need N in system information may be interpreted as Need R. The need code used within a CondX definition only applies for the case (part of the condition) where it is defined: A condition may have different need codes for different parts of the condition.

In particular, the CondX definition may contain the following examples of “otherwise the field is absent” parts.

In one example of “Otherwise, the field is absent,” the field is not relevant or may not be configured when this part of the condition applies. In particular, the UE behavior is not defined when the field is configured via another part of the condition and is reconfigured to this part of the condition. A need code is not provided when the transition from another part of the condition to this part of the condition is not supported, when the field clearly is a one-shot or there is no difference whether UE maintains or releases the value (e.g., in case the field is mandatory present according to the other part of the condition).

In one example of “Otherwise, the field is absent, Need R,” the field is released if absent when this part of the condition applies. This handles UE behavior in case the field is configured via another part of the condition and this part of the condition applies (which means that network can assume UE releases the field if this part of the condition is valid).

In one example of “Otherwise, the field is absent, Need M,” the UE retains the field if the field was already configured when this part of the condition applies. This means the network cannot release the field, but UE retains the previously configured value.

Use of different Need codes in different parts of a condition may be avoided.

For downlink messages, the need codes, conditions and ASN.1 defaults specified for a particular (child) field only apply in case the (parent) field including the particular field is present. Thus, if the parent is absent the UE may not release the field unless the absence of the parent field implies that.

For (parent) fields without need codes in downlink messages, if the parent field is absent, UE may follow the need codes of the child fields. Thus, if parent field is absent, the need code of each child field is followed (i.e., Need R child fields are released, Need M child fields are not modified and the actions for Need S child fields depend on the specified conditions of each field).

Examples of (parent) fields in downlink messages without need codes where this rule applies are: (1) nonCriticalExtension fields at the end of a message using empty SEQUENCE extension mechanism; (2) groups of non-critical extensions using double brackets (referred to as extension groups); and (3) non-critical extensions at the end of a message or at the end of a structure, contained in a BIT STRING or OCTET STRING (referred to as parent extension fields).

The handling of need codes as specified in the previous is illustrated by means of an example, as shown in the following ASN.1 in TABLE 13.

TABLE 13
Handling of need codes

```
-- /example/ ASN1START
RRCMessage-IEs ::= SEQUENCE {
  field1 InformationElement1 OPTIONAL, -- Need M
  field2 InformationElement2 OPTIONAL, -- Need R
  nonCriticalExtension RRCMessage-v1570-IEs OPTIONAL
}
RRCMessage-1570-IEs ::= SEQUENCE {
  field3 InformationElement3 OPTIONAL, -- Need M
  nonCriticalExtension RRCMessage-v1640-IEs OPTIONAL
}
RRCMessage-v1640-IEs ::= SEQUENCE {
  field4 InformationElement4 OPTIONAL, -- Need R
  nonCriticalExtension SEQUENCE { } OPTIONAL
}
InformationElement1 ::= SEQUENCE {
  field11 InformationElement11 OPTIONAL, -- Need M
  field12 InformationElement12 OPTIONAL, -- Need R
  ...,
  [[
  field13 InformationElement13 OPTIONAL, -- Need R
  field14 InformationElement14 OPTIONAL -- Need M
  ]]
}
InformationElement2 ::= SEQUENCE {
  field21 InformationElement11 OPTIONAL, -- Need M
  ...
}
-- ASN1STOP
```

The handling of need codes as specified in the previous implies that: (1) if field1 in RRCMessage-IEs is absent, UE does not modify any child fields configured within field1 (regardless of their need codes); (2) if field2 in RRCMessage-IEs is absent, UE releases the field2 (and also its child field field21); (3) if field/or field2 in RRCMessage-IEs is present, UE retains or releases their child fields according to the child field presence conditions; (4) if field1 in RRCMessage-IEs is present but the extension group containing field/3 and field/4 is absent, the UE releases field13 but does not modify field14; and (5) if nonCriticalExtension defined by IE RRCMessage-v1570-IEs is absent, the UE does not modify field3 but releases field4.

When the UE receives 1651 HO command, to make full HO information/configurations/parameters, the UE combines HO information/configurations/parameters from 1651 and HO common configuration from 1621 (here it is called as SIB-based HO common configuration(s)) based on the indication indicating whether the configuration is derived from SIB-based HO common configuration or from existing need code and/or conditions for optional information/configuration/parameter (1661).

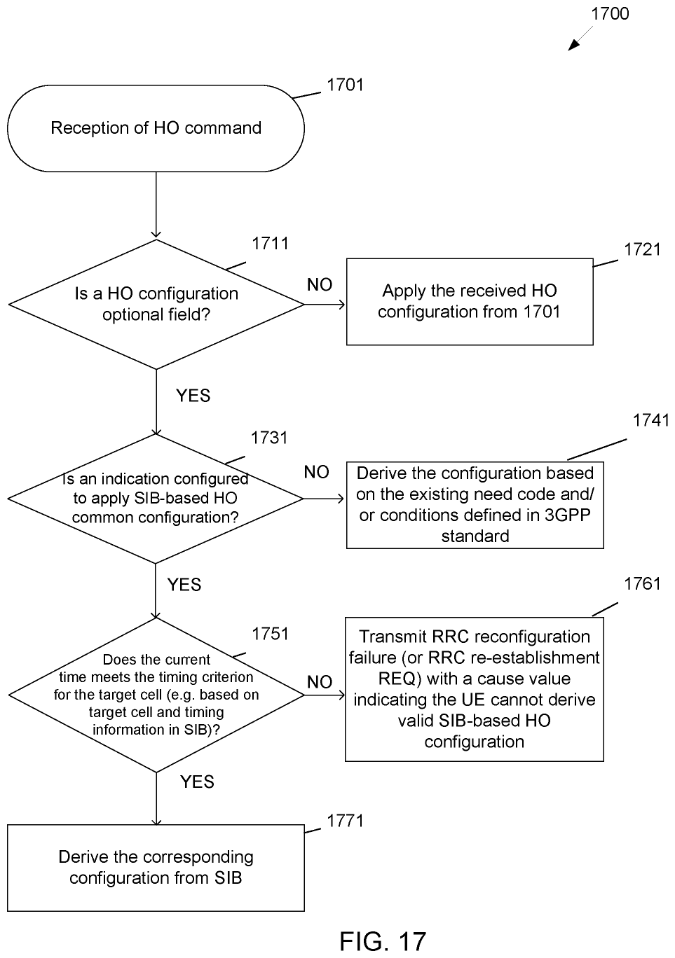

FIG. 17 illustrates flowchart of UE operation 1700 for an enhanced HO according to embodiments of the present disclosure. The UE operation 1700 as may be performed by a UE (e.g., 111-116 as illustrated in FIG. 1). An embodiment of the UE operation 1700 shown in FIG. 17 is for illustration only. One or more of the components illustrated in FIG. 17 can be implemented in specialized circuitry configured to perform the noted functions or one or more of the components can be implemented by one or more processors executing instructions to perform the noted functions.

More detailed UE behaviors are described in FIG. 17. Once the UE derives full HO information/configurations/parameters, the UE access to the target cell and transmit and/or receive data and/or control signal based on the full HO information/configurations/parameters from 1661.

In FIG. 16, it is assumed timing information #T2 is transmitted for a target cell's HO common configuration in 1613 and/or 1621. In the case, T2 means the HO common configuration for the target cell is valid until the time indicated by T2. If the current time is after the time indicated by T2, the HO common configuration is not valid. As another example, timing information #T3 and timing information #T4 can be transmitted in 1613 and/or 1621. In the case, the HO common configuration for the target cell is valid between the time indicated by T3 and the time indicated by T4. If the current time is not between two times, the HO common configuration is not valid.

FIG. 17 describes an example of UE operation flow for the enhanced HO in FIG. 16. When the UE receives a HO command (RRCReconfiguration including reconfigurationWithSync in spCellConfig of the MCG) from the serving cell (1701), the UE checks if a HO information/configuration/parameter included in the HO command is optional field (information/configuration/parameter) or not (1711). If it is not optional field, it means it is mandatory field (information/configuration/parameter) and an explicit information/configuration/parameter is included, so the UE applies the HO configuration (1721).

If it is optional field (information/configuration/parameter), the UE checks if an associated indication is configured to derive (or apply) the HO configuration from SIB-based HO common configuration (1731). If the indication is not configured, the UE derives the HO configuration based on the existing need code and/or conditions as described in FIG. 16 (e.g., 1741). If the indication is configured, the UE checks if the current time meets the timing criterion for the target cell (e.g., based on target cell information and timing information in system information in 1621 in FIG. 16) (e.g., 1751). For example, if the current time is (equal to or) before the time indicated by timing information #T2, the UE considers the current time meets the timing criterion, otherwise the UE considers the current time does not meet the timing criterion.

In another example, when it is assumed timing information #T3 and timing information #T4 are transmitted in 1621 in FIG. 16, if the current time is between the time indicated by T3 and the time indicated by T4, the UE considers the current time meets the timing criterion, otherwise the UE considers the current time does not meet the timing criterion. If the current time meets the timing criterion, the UE derives the HO configuration from the corresponding ones that received via system information (or system information block) (1771).

If the current time does not meet the timing criterion, the UE transmits a corresponding failure message (e.g., RRC reconfiguration failure message or RRC re-establishment REQ message) with a cause value indicating the UE cannot derive the valid corresponding HO configuration from the ones that received via system information (1761). Note although the examples in FIG. 16 and FIG. 17 are described assuming HO in NTN, they can be also applied to HO in TN case.

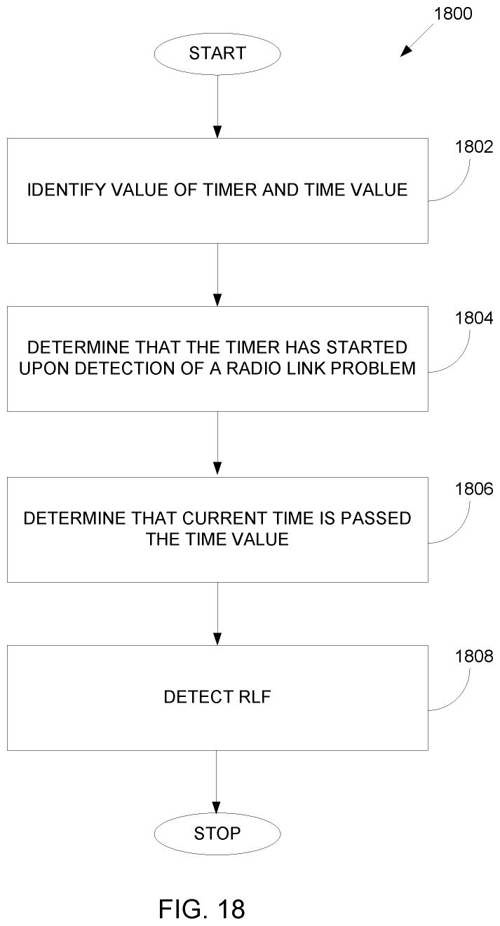

FIG. 18 illustrates a flowchart of UE method 1800 for an enhanced RLF detection in NTN according to embodiments of the present disclosure. The UE method 1800 as may be performed by a UE (e.g., 111-116 as illustrated in FIG. 1). An embodiment of the UE method 1800 shown in FIG. 18 is for illustration only. One or more of the components illustrated in FIG. 18 can be implemented in specialized circuitry configured to perform the noted functions or one or more of the components can be implemented by one or more processors executing instructions to perform the noted functions.

As illustrated in FIG. 18, the method 1800 begins at step 1802. In step 1802, a UE identifies a value of a timer and a time value. In one example, the time value is a time that identifies when a quasi-Earth fixed cell stops serving an area that is currently being served. In another example, the timer us T310, the time value is T service, and the first counter is N310.

In step 1804, the UE determines that the timer has started upon detection of a radio link problem, wherein the radio link problem is based on a first counter.

In step 1806, the UE determines that a current time is passed the time value.

In step 1808, the UE detects a radio link failure based on a determination that the timer has started and the current time is passed the time value.

In one embodiment, the UE receives configuration information for the value of the timer, the time value and the first counter via a SIB or a UE dedicated RRC message.

In one embodiment, the UE identifies that the radio link problem is detected when a received number of consecutive out-of-sync indications from a lower layer reaches the first counter.

In one embodiment, the UE determines that the radio link failure is detected based on a determination that the UE is located out of a distance threshold from a reference location.

In one embodiment, the UE receives the reference location and the distance threshold via a SIB or a UE dedicated RRC message.

In one embodiment, the UE receives a scaling factor via a SIB or a UE dedicated RRC message.

In one embodiment, the UE applies the scaling factor to the value of the timer.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) comprising:
a transceiver; and
a processor operably coupled to the transceiver, the processor configured to:
identify a value of a timer and a time value;
determine that the timer has started upon detection of a radio link problem, wherein the radio link problem is based on a first counter;
determine that a current time is passed the time value; and
detect a radio link failure based on a determination that the timer has started and the current time is passed the time value.

2. The UE of claim 1, wherein the transceiver is configured to receive configuration information for the value of the timer, the time value and the first counter via a system information block (SIB) or a UE dedicated radio resource control (RRC) message.

3. The UE of claim 1, wherein the processor is further configured to identify that the radio link problem is detected when a received number of consecutive out-of-sync indications from a lower layer reaches the first counter.

4. The UE of claim 1, wherein the time value is a time that identifies when a quasi-Earth fixed cell stops serving an area that is currently being served.

5. The UE of claim 1, wherein the processor is further configured to determine that the radio link failure is detected based on a determination that the UE is located out of a distance threshold from a reference location.

6. The UE of claim 5, wherein the transceiver is further configured to receive the reference location and the distance threshold via a system information block (SIB) or a UE dedicated radio resource control (RRC) message.

7. The UE of claim 1, wherein:
the timer is T310,
the time value is T service, and
the first counter is N310.

8. The UE of claim 1, wherein the transceiver is further configured to receive a scaling factor via a system information block (SIB) or a UE dedicated radio resource control (RRC) message.

9. The UE of claim 8, wherein the processor is further configured to apply the scaling factor to the value of the timer.

10. A method of a user equipment (UE), the method comprising:
identifying a value of a timer and a time value;
determining that the timer has started upon detection of a radio link problem, wherein the radio link problem is based on a first counter;
determining that a current time is passed the time value; and
detecting a radio link failure based on a determination that the timer has started and the current time is passed the time value.

11. The method of claim 10, further comprising receiving configuration information for the value of the timer, the time value and the first counter via a system information block (SIB) or a UE dedicated radio resource control (RRC) message.

12. The method of claim 10, further comprising identifying that the radio link problem is detected when a received number of consecutive out-of-sync indications from a lower layer reaches the first counter.

13. The method of claim 10, wherein the time value is a time that identifies when a quasi-Earth fixed cell stops serving an area that is currently being served.

14. The method of claim 10, further comprising determining that the radio link failure is detected based on a determination that the UE is located out of a distance threshold from a reference location.

15. The method of claim 14, further comprising receiving the reference location and the distance threshold via a system information block (SIB) or a UE dedicated radio resource control (RRC) message.

16. The method of claim 10, wherein:
the timer is T310,
the time value is T service, and
the first counter is N310.

17. The method of claim 10, further comprising receiving a scaling factor via a system information block (SIB) or a UE dedicated radio resource control (RRC) message.

18. The method of claim 17, further comprising applying the scaling factor to the value of the timer.
